(19) United States
(12) Patent Application Publication
(10) Pub. No.: US 2026/0093899 A1
(43) Pub. Date: Apr. 2, 2026

(54) COLLABORATION ON AN ASSET USING A GENERATIVE RESPONSE ENGINE

(71) Applicant: OpenAI OpCo, LLC., San Francisco, CA (US)

(72) Inventors: Bryan Ashley, San Francisco, CA (US); Lee Byron, San Francisco, CA (US); Kai Chen, San Francisco, CA (US); Alexi Christakis, San Francisco, CA (US); Noah Deutsch, San Francisco, CA (US); Thomas Dimson, San Francisco, CA (US); Tarun Gogineni, San Francisco, CA (US); Daniel Levine, San Francisco, CA (US); Matthew Lim, San Francisco, CA (US); Bryant Jow, Palo Alto, CA (US); Akshay Nathan, San Francisco, CA (US); Karina Nguyen, San Francisco, CA (US); Michael Wu, San Francisco, CA (US)

(73) Assignee: OpenAI OpCo, LLC., San Francisco, CA (US)

(21) Appl. No.: 19/043,013

(22) Filed: Jan. 31, 2025

Related U.S. Application Data
(60) Provisional application No. 63/700,946, filed on Sep. 30, 2024.

(51) Int. Cl. G06Q 10/101; G06F 40/166; H04L 51/02; H04L 51/216

(52) U.S. Cl. CPC G06F 40/166; H04L 51/02; H04L 51/216

(57) ABSTRACT

The present technology can integrate a generative response engine capable of dynamically determining and displaying generated content in appropriate user interface formats. In response to user prompts, the generative response engine can display content in a content frame separate from the traditional conversational interface. The system intelligently assesses the nature of the content and determines the most suitable display mode, enhancing user interaction and collaboration. This interface facilitates both content creation and user collaboration by enabling seamless transitions between conversational responses and rich media content, such as drawings, games, or documents. The system thus optimizes content interaction based on its type and user needs, supporting diverse use cases across media formats.

### CROSS-REFERENCE TO RELATED APPLICATIONS

This application claims priority to U.S. provisional application number 63/700,946, filed on Sep. 30, 2024, entitled “SELECTIVE INTERACTION WITH A PORTION OF CONTENT BY A GENERATIVE RESPONSE ENGINE”, which is expressly incorporated by reference herein in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the present technology.

FIG. 2 illustrates an example method for displaying an asset in a collaborative surface of a user interface that facilitates collaboration on the asset between a user account and the generative response engine in accordance with some aspects of the present technology.

FIG. 3 illustrates an exemplary user interface that demonstrates the capability of a generative response engine to both engage in conversational dialogue and generate an asset located in a collaborative surface separate from a conversational interface in accordance with some aspects of the present technology.

FIG. 4A, FIG. 4B, and FIG. 4C illustrates a sequence of user interfaces where the user account determines that an asset should be displayed in a collaborative surface separate from the conversational interface in accordance with some aspects of the present technology.

FIG. 5 illustrates a method for interacting with an asset by a generative response engine in accordance with some aspects of the present technology.

FIG. 6 illustrates an example method for selectively interacting with a portion of an asset by a generative response engine while leaving a non-selected portion of the asset unchanged in accordance with some aspects of the present technology.

FIG. 7 illustrates an example of a user interface wherein a portion of the asset is selected by reference to the asset in accordance with some aspects of the present technology.

FIG. 8 illustrates a method for rendering an asset in an interactive interface in accordance with some aspects of the present technology.

FIG. 9A and FIG. 9B illustrate an example of a user interface where a portion of an asset is selected in accordance with some aspects of the present technology.

FIG. 10 illustrates an example method for anchoring a comment provided by the generative response engine to a relevant portion of an asset in accordance with some aspects of the present technology.

FIG. 11A and FIG. 11B illustrate interactions of a user account with portions of an asset displayed in a collaborative surface using a shortcut to a common prompt in accordance with some aspects of the present technology.

FIG. 12 illustrates another example of common prompts in accordance with some aspects of the present technology.

FIG. 13 illustrates a mobile user interface in accordance with some aspects of the present technology.

FIG. 14 illustrates that the present technology can be integrated with third-party applications according to some aspects of the present technology.

FIG. 15 illustrates that revisions to an asset can be stored in history log that can enable undo actions and revision markup in accordance with some aspects of the present technology.

FIG. 16 is a block diagram illustrating an example machine-learning platform for implementing various aspects of this disclosure in accordance with some aspects of the present technology.

FIG. 17A, FIG. 17B, and FIG. 17C illustrates an example transformer architecture in accordance with some aspects of the present technology.

FIG. 18 shows an example of a system for implementing some aspects of the present technology.

### DETAILED DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. However, despite their remarkable linguistic prowess, these generative response engines operate on a foundation of publicly available information and do not possess personal information about individual users.

Many generative response engines provide a conversational user interface utilizing a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant.

The conversational user interface, however, is not well suited for some tasks. In particular, the conversational user interface is not effective when working on a project when the user account might desire to focus the generative response engine on a selected portion of the content.

There are a few reasons why the conversational user interface is not effective for these types of tasks. One reason is that interactions with the generative response engine generally result in the full text of a chat thread being made available to the generative response engine, and even when a user tries to reference a selected portion of the content in a prompt, the generative response engine will generate all tokens used to create that content in response to the prompt, and will not limit itself to generating only the selected portion of the content. This artifact of the operation of interacting with the generative response engine through a chatbot interface can be frustrating when non-selected portions of the content are revised by the generative response engine, contrary to the instructions in the prompt.

Another reason that the conversational user interface is not effective for these types of tasks is that the content is generally presented in line with the chat thread. This is not effective because, especially for longer content, the user account might want to reference a selected portion of the content while providing a prompt. But when the content is in line with the chat thread, the prompt is often provided at the bottom of the thread.

User accounts often interact with a chatbot generative response engine as if the chatbot were a skilled assistant. And user accounts are accustomed to more intuitive methods of interacting with a skilled assistant. Often, both the user and the skilled assistant might look at the same portion of the content together, or they might share a document and place comments anchored to the portion of the content they are collaborating on.

Given that users are already accustomed to such type of interaction, the present technology blends aspects of a conversational user interface with a shared document-type user interface to make it more effective to work with a generative response engine to collaborate on content. For example, the present technology can provide a user interface that includes a collaborative surface (e.g., a sub-window or pane within the user interface) through which a user account can interact directly with an asset. As used herein, an “asset” can refer to any content displayed in the collaborative surface. For example, an asset can be a document, code, applet, image, video, table, graphic, or any other content capable of being rendered and presented.

In some aspects, the generative response engine can determine, based on a prompt, to launch the collaborative surface tool. For example, a user account can provide an explicit prompt such as, “Draft an email using the collaborative surface,” or a prompt with a key word or intent to trigger the generative response engine to launch the collaborative surface. As an example, a user account can provide a prompt such as, “Draft an email,” or “Write program code in C++.” In these examples, the collaborative surface tool can be launched by the generative response engine based on a determination of the intent of the user account to work on a document or other asset. In some examples, the generative response engine can be post-trained to recognize scenarios in which providing a response or asset via the collaborative surface is beneficial. For example, the generative response engine can be post-trained to determine that a user account has requested an output, such as long-form text or a graphic, that should be displayed via the collaborative surface rather than in the chat window. In some examples, the generative response engine can also be post-trained to recognize whether the user account intends to work collaboratively on an asset with the generative response engine. In another example, a user account can provide a file or long form input (e.g., a document file, text file, image file, code segment, document portion, etc.) in a prompt. The generative response engine can determine that the user account intends to edit or otherwise modify the file or long-form input and can launch the collaborative surface tool and display the contents of the file or the long-form input. This can reduce the number of prompts required from the user to complete the user's intended task, thereby improving user experience and increasing efficiency.

The collaborative surface can facilitate interaction by a user account with an asset displayed in the collaborative surface. As a non-limiting example, a user account can provide a prompt in the chat window requesting that the generative response engine draft a thank you email for an interview. The prompt can be received at a front end of the system and be provided to the generative response engine as input. The generative response engine can determine, based on the prompt, to launch the collaborative surface tool and can output tokens thereby generating the requested email. The front end can display the output email in the collaborative surface. The user account can directly edit or otherwise modify the email directly in the collaborative surface, or can provide a prompt in the chat box requesting that the generative response engine modify the asset (e.g., the email) or a portion of the asset. For example, the user account can provide the prompt, “Make the email sound more professional.” The front end can provide two inputs to the generative response engine-the prompt itself to make the email sounds more professional and a whisper message containing the email as displayed in the collaborative surface. The whisper, or hidden, message may be a message to the generative response engine that is sent by the front end without being displayed to the user account.

In some examples, the user account can interact with the generative response engine on an asset via the collaborative surface as if collaborating on an asset (e.g., a document or other work product) with a human in real time. For example, the user account can modify (e.g., add, edit, or delete) portions of the asset in the collaborative window. While modifying the asset, the user account can provide prompts, causing the generative response engine to update the asset in real time. For example, a user account can select a portion of the asset, such as a portion of text (e.g., a word, a sentence fragment, a sentence, a paragraph, etc.), one or more elements of an image or graphic, a portion of a table (e.g., a cell, a row, a column, etc.), and the like. The user account can provide a prompt in the chat box referencing the selected portion of the asset such that the generative response engine can provide an output modifying only the selected portion of the asset as requested in the prompt. By only generating output tokens associated with the selected portion of the asset, the generative response engine can respond to the prompt to modify the selected portion of the asset more quickly than if it were to output tokens associated with the entire asset. In other examples, the generative response engine may output tokens associated with the entire asset, but may cause the content of the selected portion of the asset to be modified.

In another example, the user account can request feedback on the asset, or on a selected portion of the asset, from the generative response engine, which can be provided as comments on the asset displayed via the collaborative surface. For example, the user account can select a portion of the asset as described above and provide a prompt requesting feedback regarding the selected portion of the asset. The output of the generative response engine can appear as a comment bubble or comment window associated with the selected portion of the asset in the collaborative surface. Accordingly, the collaborative surface can enable a user to prompt the generative response engine to make targeted modifications or targeted comments such that the generative response engine does not modify or comment on the non-selected portions of the asset. This facilitates seamless interaction with the generative response engine by the user and eliminates pain points associated with collaborating, by a human user, with a chatbot or generative response engine, thereby improving user experience and user adoption.

Accordingly, as described above, the collaborative surface facilitates real-time collaboration with the generative response engine on an asset by a user account and the generative response engine. In some examples, multiple user accounts can collaborate on an asset via the collaborative surface, while also collaborating with the generative response engine. Disclosed technologies facilitate interaction with the generative response engine as if the user account and generative response engine are working together on the asset in real time, thereby improving user experience and enabling seamless use of the generative response engine as a collaboration tool for producing an asset (e.g., a document, image, code, table, etc.).

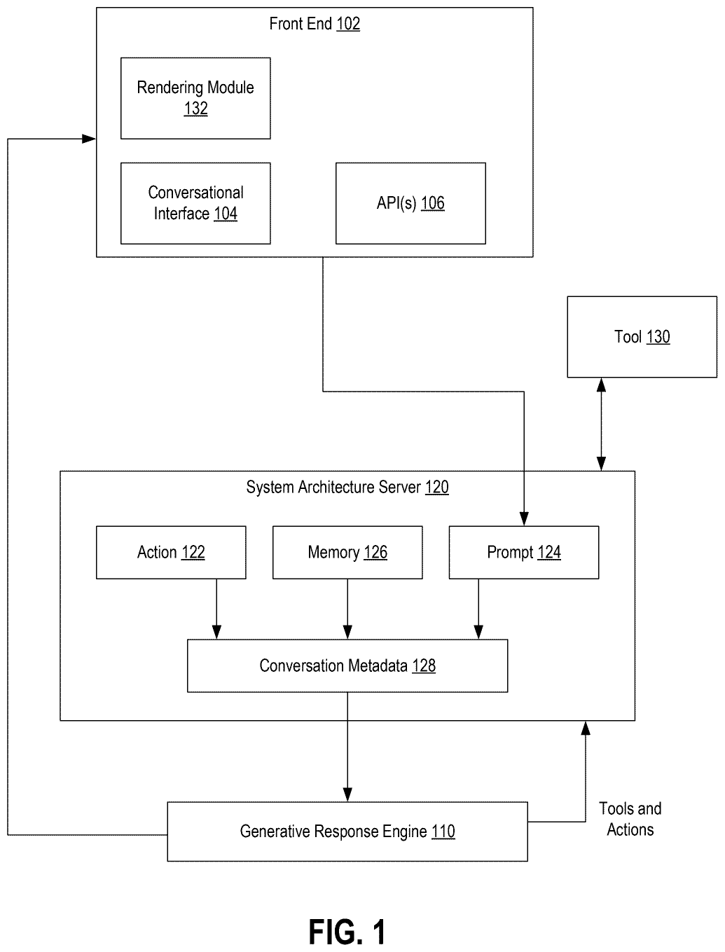

FIG. 1 illustrates an example system supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

Generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., a generative pre-trained transformer) and combinations of models.

In some instances, a language model, such as CHATGPT, can receive prompts to output images, video, code, applications, etc., which it can provide by interfacing with one or more other models, as will be addressed further herein.

Users and applications can interact with generative response engine 110 through front end 102. Front end 102 serves as the interface and intermediary between the user and the generative response engine. It encompasses graphical user interface 104 and Application Programming Interfaces (APIs) 106 that facilitate communication, input processing, and output presentation. Generally, users interact through graphical user interface 104 that often includes a conversational interface, and applications interact through API 106, but this is not a requirement.

Graphical user interface 104 is the platform through which users interact with generative response engine 110. It can be a web-based chat window, a mobile application, or any interface that supports data input and output. Graphical user interface 104 facilitates a conversation between the user and the generative response engine, as the user provides prompts in the graphical user interface 104 to which the generative response engine responds and presents those responses in graphical user interface 104. In some aspects, graphical user interface 104 presents a conversational interface, which has attributes of a conversation thread between a user account and generative response engine 110.

Graphical user interface 104 is configured to perform input handling, context management, and output presentation. The type of inputs that can be received can be relative to the specifics of generative response engine 110. But even when a model doesn't directly accept certain types of inputs, front end 102 might be able to receive different types of inputs, which can be converted to inputs that are accepted by generative response engine 110. For example, a language model is generally configured to accept text, but front end 102 can accept voice and convert it to text or accept an image and create a textual representation.

Graphical user interface 104 is also configured to maintain the context of the conversation, which allows for coherent and relevant responses. For example, graphical user interface 104 is responsible for providing the conversation thread and other relevant context accessible to front end 102 to the generative response engine along with the specific prompt to the generative response engine. In an example, a conversation between the user account and generative response engine 110 can have taken several turns (prompt, response, prompt, response, etc.). When the user account provides a further prompt, graphical user interface 104 can provide that prompt to the generative response engine in the context of the entire conversation.

In another example, front end 102 might have access to memory 126 where facts about the user account have been stored. In some aspects, these facts can have been identified as facts worth storing by the generative response engine and front end 102 has stored these facts at the direction of the generative response engine. Accordingly, these facts can be provided to generative response engine 110 along with a user-provided prompt so that the generative response engine has access to these facts when generating a response.

In another example, graphical user interface 104 might be configured to provide a system prompt along with a user-provided prompt. A system prompt is hidden from the user account and is used to set the behavior and guidelines for the generative response engine. It can be used to define the AI's persona, style, and constraints.

In some aspects, front end 102 is implemented as a web application and serves as the primary interface for user interaction. As will be addressed herein, the present technology provides a conversational interface and a collaborative surface, wherein the conversational interface can be used to provide instructions for interacting with an asset in the collaborative surface. The front end processes user inputs, updates the user interface in real-time, and provides an optimistic preview of generative response engine 110 outputs until the outputs are complete, as addressed below. This includes dynamically highlighting text, rendering partial changes, and displaying animations to indicate ongoing edits. By resolving ambiguities in streamed tokens and predicting intermediate states, the front end ensures that users can interact with the system in real time, even before the model's output is finalized.

The collaborative surface is provided by graphical user interface 104 and includes a document editor, a code editor, a visual media editor, an audio editor, or any other tool to facilitate collaboration on an asset between a user account and generative response engine 110. As discussed above, a decision boundary can be used by generative response engine 110 to recognize that it should launch the collaborative surface and/or a particular tool of the collaborative surface (e.g., a text editor or code editor). In some examples, generative response engine 110 can recognize keywords or intents within a prompt and determine that it should launch the collaborative surface. For example, a prompt can include a request to generate an asset or content of a particular type (e.g., an email, a document, code, a table, an image, etc.). In another example, generative response engine 110 can be post-trained to recognize an intent of a user account to work collaboratively with generative response engine 110 on an asset. In another example, the prompt itself can include text or code and generative response engine 110 can determine that output including the text or code, or a modified portion thereof, is more easily or effectively viewed via the collaborative surface.

Graphical user interface 104 is also configured to display the responses from the generative response engine, which might include text, code snippets, images, or interactive elements.

In some aspects, generative response engine 110 can provide instructions to front end 102 that instruct graphical user interface 104 about how to display some of the output from the generative response engine. For example, the generative response engine can direct graphical user interface 104 to present code in a code-specific format, or to present interactive graphics, or static images. In other examples, the generative response engine can direct graphical user interface 104 to present an interactive document editor where graphical user interface 104 can be presented with the document editor so that the user account and the generative response engine can collaborate on the document. In some aspects, generative response engine 110 can provide instructions to front end 102 to record facts in a personalization notepad. Accordingly, graphical user interface 104 does not always display all of the output of the generative response engine.

As noted above, front end 102 can also provide one or more application programming interfaces (API(s)) 106. APIs enable developers to integrate the generative response engine's capabilities into external applications and services. They provide programmatic access to the generative response engine, allowing for customized interactions and functionalities.

APIs 106 can accept structured requests containing prompts, context, and configuration parameters. For example, an API can be used to provide prompts and divide the prompt into system prompts and user prompts. In some aspects, APIs 106 can provide specific inputs for which generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that generative response engine 110 might be trained to interpret. For example, the moderation API can take advantage of the generative response engine's content moderation decision-making. In the case of the moderation API and others, the API might give access to services other than the generative response engine. For example, the moderation API might be an interface to moderation system 138, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, graphical user interface 104 and APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is system architecture server 120. The function of system architecture server 120 is to manage and organize the flow of data among key subsystems, enabling generative response engine 110 to generate responses that are contextually relevant, accurate, and enriched with additional information as required.

Action 122 facilitates auxiliary tasks that extend beyond basic text generation. In some aspects, action 122 can be actions that correspond to API 106. In some aspects, action 122 can be agentic actions that generative response engine 110 decides to take to carry out a user's intent as described in the prompt.

Prompt 124 is the request or command provided by the user account through front end 102. In some aspects, prompt 124 can be further supplemented by a system prompt and other information that might be included by graphical user interface 104 or API 106. In some aspects, prompt 124 can even be modified or enhanced by generative response engine 110 as addressed further below. Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. Generally, prompt 124 will include an entire conversation thread, but in some instances, prompt 124 might need to be shortened if it exceeds a maximum accepted length (generally measured by a number of tokens).

System architecture server 120 can also route prompts and response through moderation system 138, which can be separate or part of system architecture server 120. In some aspects, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some aspects, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some aspects, memory can be recorded at the instruction of generative response engine 110 when generative response engine 110 identifies a fact or data that it determines should be saved in memory because it might be useful in later conversations or sessions.

Collaborative Asset Service 140 is the system's persistent storage and coordination hub for working with collaborative assets in a collaborative surface. Collaborative asset service 140 receives inputs from both the user and the model, merging them into a unified, event-sourced representation of the document. Event sourcing allows collaborative asset service 140 to store changes as a sequence of discrete events, such as text edits, comments added or removed, and other collaborative actions. This approach not only ensures document consistency across sessions but also enables advanced features like undo/redo, change tracking, and state restoration. For example, collaborative asset service 140 can reconstruct the exact state of a document at any point in time by replaying the stored events. When generative response engine 110 completes a data structure describing a set of changes, collaborative asset service 140 applies these changes deterministically, ensuring that the document's state remains consistent and reliable.

A key aspect of this architecture is the collaboration between front end 102 and collaborative asset service 140. While front end 102 provides an immediate, interactive experience, collaborative asset service 140 ensures the durability and accuracy of the document state. This integration allows users to edit documents collaboratively. For instance, front end 102 can interpret partial data structures generated by generative response engine 110 and interpolate intermediate states, providing users with a fluid and intuitive experience, but the actual asset state is not updated at collaborative asset service 140 until the output of generative response engine 110 is determined.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from system architecture server 120) and generates outputs. In some aspects, the generative response engine is a Generative Pre-trained Transformer (GPT), but it could utilize other architectures.

A core feature of generative response engine 110 is to generate content in response to prompts. When generative response engine 110 is a GPT, it is configured to receive inputs from front end 102 that provide guidance on a desired output. The generative response engine can analyze the input and identify relevant patterns and associations in the data, and it has learned to generate a sequence of tokens that are predicted as the most likely continuation of the input. Generative response engine 110 generates responses by sampling from the probability distribution of possible tokens, guided by the patterns observed during its training. In some aspects, generative response engine 110 can generate multiple possible responses before presenting the final one. Generative response engine 110 can generate multiple responses based on the input, and these responses are variations that generative response engine 110 considers potentially relevant and coherent.

In some aspects, generative response engine 110 can evaluate generated responses based on certain criteria. These criteria can include relevance to the prompt, coherence, fluency, and sometimes adherence to specific guidelines or rules, depending on the application. Based on this evaluation, generative response engine 110 can select the most appropriate response. This selection is typically the one that scores highest on the set criteria, balancing factors like relevance, informativeness, coherence, and content moderation instructions/training.

In some aspects, an instruction provided by API 106, a system prompt, or a decision made by generative response engine 110 can cause generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to tool 130 or provided to generative response engine 110 to yield a better output response than the original prompt might have.

Generative response engine 110 can also do more than generate content in response to a prompt. In some aspects, generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ), and the generative response engine can utilize a decision boundary to recognize that it needs to plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, generative response engine 110 might call tool 130 or cause action 122 to be performed. As indicated above, tools 130 can include internet browsers, editors such as code editors, document editors, other AI tools etc. Actions 122 are actions that generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that generative response engine 110 can control the computer operating system on the user's behalf, to robotic actuators, to search browsers and specific applications.

Additionally, generative response engine 110 can also generate portions of responses that are not displayed to the user. For example, generative response engine 110 can direct front end 102 to provide specific behaviors, such as directions for how to present the response from generative response engine 110 to the user account. In another example, generative response engine 110 can provide response portions dictated by an API, where portions of the response to the API might be for the consumption of the calling application but not for presentation to the end user.

In some aspects, the output of the generative response engine can be further analyzed by output safety system 136. While generative response engine 110 can perform some of its own moderation, there can be instances where it is desired to have another service review outputs for compliance with the moderation policy. The use of dashed lines in FIG. 1 differentiates a path using output safety system 136 and not using output safety system 136.

While FIG. 1 shows responses being provided back to front end 102 directly, in some aspects, the responses might be returned by way of system architecture server 120.

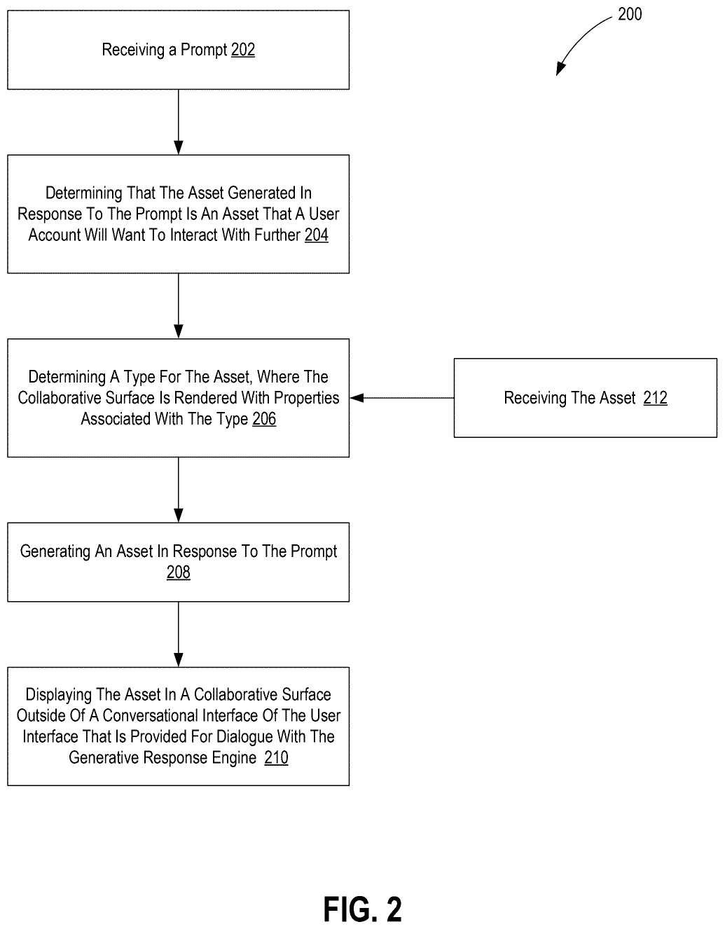

FIG. 2 illustrates example method 200 for displaying an asset in a collaborative surface of a user interface that facilitates collaboration on the asset between a user account and the generative response engine in accordance with some aspects of the present technology. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

In order to collaborate on an asset between a user account and the generative response engine (e.g., generative response engine 110 described with reference to FIG. 1), an asset needs to be visually rendered and presented via an interactive interface, such as the collaborative surface. In some examples, the asset can be generated by the generative response engine (e.g., as described with reference to block 202 and block 204) or can be provided to the generative response engine (e.g., as described with reference to block 212).

At block 202, the generative response engine can receive a prompt via a chat box of an interface. The prompt can include a request for the generative response engine to generate content. The prompt can indicate, for example, a particular type of content to be output by the generative response engine, such as text, code, an image, a table, etc.

Not all content that is generated by the generative response engine is of a type with which a user will want to collaborate. Thus, according to some examples, at block 204, method 200 includes determining that the asset that may be generated in response to the prompt is an asset that a user account will want to interact with further. For example, generative response engine 110 illustrated in FIG. 1 may determine that the asset to be generated in response to the prompt is an asset that a user account will want to interact (e.g., revise, modify, or edit) with further. Some content generated by the generative response engine might be short content and might be more appropriate to interact with in a traditional chat interface, i.e., via the chat box of the interface. To handle this complexity, the generative response engine can be trained or post-trained to determine when it is likely that the asset being generated, or that has been generated, is an asset that should be displayed in a user interface that facilitates collaboration on the asset between a user account and the generative response engine (e.g., via the collaborative surface), or that the asset should be displayed in a conversational user interface more typical for a chatbot.

In some examples, method 200 can begin at block 212 with the user account providing content or an asset to the generative response engine as part of a prompt. For example, a prompt can request that the generative response engine edit a document provided as a document file or pasted as text in the chat box of the interface.

As noted above, an asset or content can also be received from the user account. According to some examples, method 200 can include receiving the asset or the content at block 212. For example, generative response engine 110 illustrated in FIG. 1 may receive the asset as part of a prompt or as an additional prompt. In some examples, the asset can be provided by the user account to the generative response engine as a file or attachment to a prompt, or the asset can be a file or attachment provided to the generative response engine by a third-party application through an API.

While it might be more likely that the content that is uploaded is content that should be rendered in a separate frame from a conversational thread, this might not always be the case. Just as at block 204, the generative response engine can decide how to best display this content. FIG. 2 does not illustrate a decision boundary for uploaded content, but the generative response engine can have this capability.

Drawings, graphs, documents, videos, etc., might benefit from different user interfaces. As discussed above, the collaborative surface can include one or more tools, such as a text editor, a code editor, and image editor, etc. According to some examples, at block 206, method 200 can include determining a type for the asset, such that the collaborative surface is rendered by the front end with properties associated with the type of the asset. An example of some properties might be layout properties, tools properties (e.g., different selection tools like an area selector for graphical formants and a text cursor for text documents, etc.), shortcuts (e.g., buttons that map to pre-populated prompts that might be common for the content type).

At block 208, the generative response engine can generate the content in response to the prompt. For example, if the prompt requests that the generative response engine draft an email within certain parameters, the generative response engine can output an email within the parameters for display in the collaborative surface. In some examples, the generative response engine outputs tokens that are streamed to a front end (e.g., front end 102 described with reference to FIG. 1).

According to some examples, at block 210, method 200 can include displaying the asset in a collaborative surface outside of a conversational interface of the user interface that is provided for dialogue with the generative response engine. For example, front end 102 illustrated in FIG. 1 may display the asset in a collaborative surface outside of a conversational interface of the user interface that is provided for dialogue with generative response engine 110.

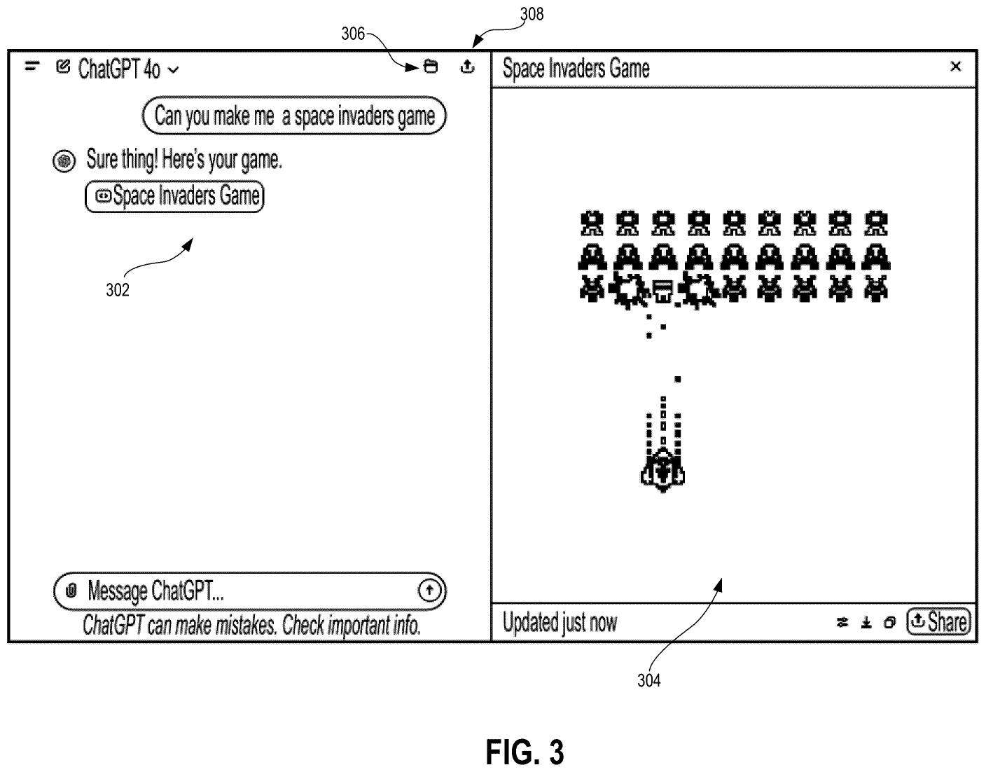

FIG. 3 illustrates exemplary user interface 300 that demonstrates the capability of a generative response engine (e.g., generative response engine 110 described with reference to FIG. 1) to both engage in conversational dialogue and generate an asset, and to locate the asset in a collaborative surface separate from a conversational interface in accordance with some aspects of the present technology.

User interface 300 illustrated in FIG. 3 shows conversational interface 302 and collaborative surface 304 displayed by front end 102. In conversational interface 302, the user account has initiated a prompt asking for a “Space Invaders” game. In response to this prompt, the generative response engine has generated the asset (e.g., the game) in collaborative surface 304, which is displayed adjacent to conversational interface 302. The game is created by generative response engine 110 in code, which is executed and displayed in collaborative surface 304.

Notably, the generative response engine is capable of dynamically determining that the type of asset—here, an interactive game—should be rendered in a collaborative surface rather than being confined to a traditional chat window. The collaborative surface is rendered with properties associated with the interactive game type. In this example, the options are to save asset 306 and upload content 308.

Collaborative surface 304 shows the user engaging with the asset (e.g., the game). In this case, the asset is an interactive game that allows further user engagement and interaction beyond simple text-based exchanges. This collaborative surface operates separately from the ongoing dialogue in conversational interface 302, allowing a more tailored user experience for specific asset types. Moreover, this asset can be modified or extended through further interaction with the generative response engine, allowing for collaborative asset development.

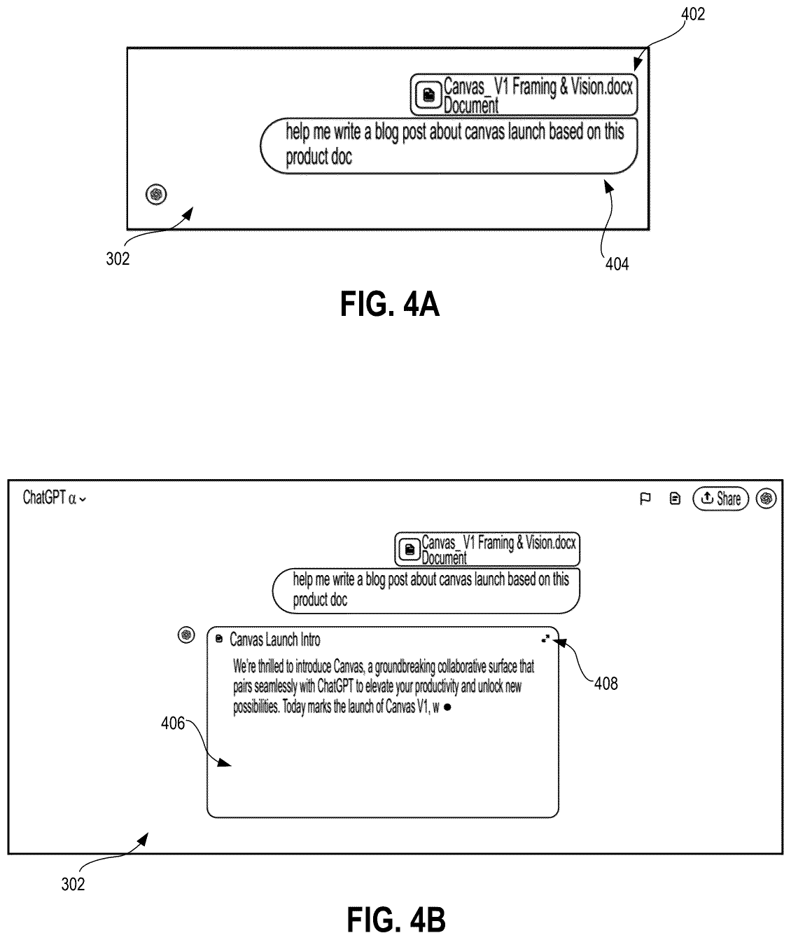

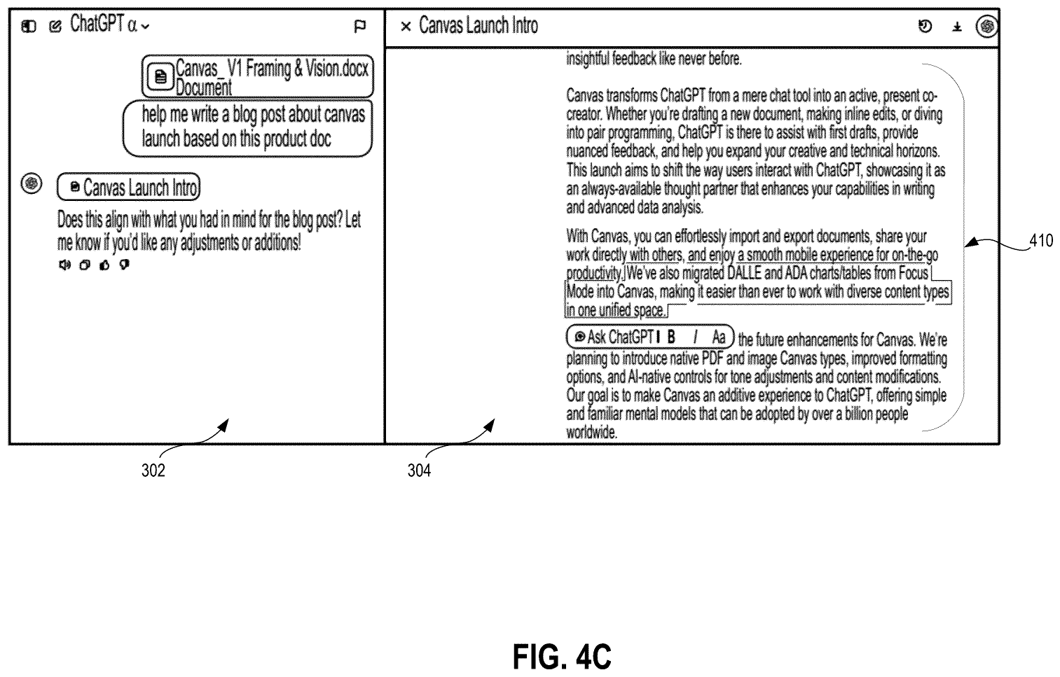

FIG. 4A, FIG. 4B, and FIG. 4C illustrate a sequence of user interfaces where the user account determines that an asset generated by the generative response engine should be displayed in a collaborative surface separate from the conversational interface of the user interface, in accordance with some aspects of the present technology.

In FIG. 4A, the user account has uploaded content 402 (e.g., text stored as a document file) and provided prompt 404 in association with the content 402. In FIG. 4A, the user account is interacting with the generative response engine in conversational interface 302.

In FIG. 4B, the generative response engine creates response 406 to prompt 404, but response 406 is provided in conversational interface 302. Response 406 can be generated by the generative response engine based on the intent of prompt 404. For example, the generative response engine can be post-trained to recognize that the intent of prompt 404 is to get help writing a blog post, which implies a desire for continued interaction with the generative response engine to write a blog post. Based on this determination, the generative response engine can output response 406, informing the user of the availability of the collaborative surface tool. As shown in FIG. 4B, response 406 can be displayed with selectable transition option 408, which, when activated by a user account controlling a user interface device, can cause front end 102 to open collaborative surface 304.

In FIG. 4C, front end 102 opens collaborative surface 304. Collaborative surface 304 can display text 410 of the blog post output by the generative response engine in response to prompt 404 and content 402. Text 410 rendered by front end 102 in collaborative surface 304 of the user interface can be interactive, such that the user account can modify text 410 as if using a word processing application. In some examples, the user interface can also include conversational interface 302 such that a user can view the asset (e.g., the blog post containing text 410) side-by-side with the message history. This allows the user to view context for the asset or current version of the asset alongside any prompts provided to the generative response engine to modify or comment on the asset.

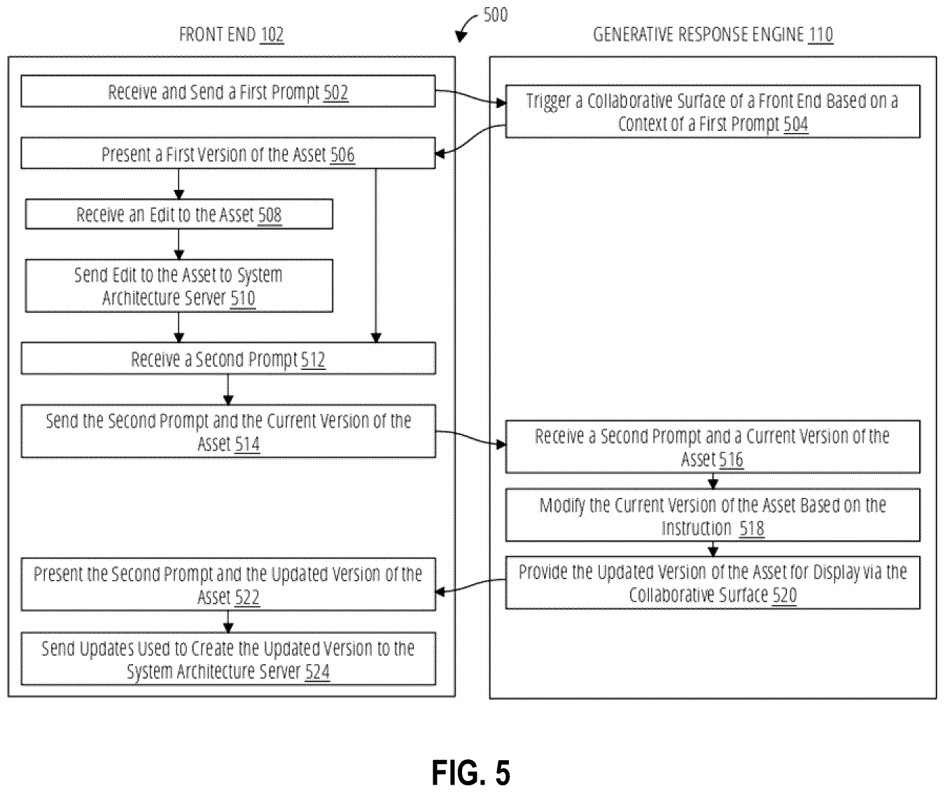

FIG. 5 illustrates example method 500 for interacting with an asset by a generative response engine in accordance with some aspects of the present technology. Although example method 500 depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

As addressed herein, one aspect of the present technology is that one or more users and the generative response engine can collaborate on the same asset). The user can edit the asset, and so can the generative response engine. And the present technology provides mechanisms by which the generative response engine can be aware of the changes the user has made, and the user can easily perceive the changes that the generative response engine has made.

According to some examples, method 500 includes receiving and sending a first prompt at block 502. For example, front end 102 illustrated in FIG. 1 may receive and send the first prompt.

According to some examples, at block 504, method 500 can include triggering, by the generative response engine (e.g., generative response engine 110 described with reference to FIG. 1), a collaborative surface (e.g., collaborative surface 304) of the front end based on a context of a first prompt. For example, the collaborative surface can be an interactive interface in the user interface. In some examples, the collaborative surface can be displayed side-by-side with a conversational interface such that a user can simultaneously view a message history in the conversational interface and an asset in the collaborative surface.

According to some examples, front end 102 illustrated in FIG. 1 may present a first version of the asset. The first version of the asset is the first version generated by the generative response engine or provided by the user account.

Once the asset has been rendered in the collaborative surface, the user can modify the asset directly at any time. In addition, the user can also interact with the conversational interface to prompt the generative response engine to make changes to the asset, which, in most cases will cause the generate generative response engine to make changes to the asset. Not all prompts cause the generative response engine to make changes to the asset, though. Some prompts can request the generative response engine to further a conversation about the document, and these prompts would cause the generative response engine to respond in the conversational interface. Accordingly, to support just the interactions, the generative response engine has been trained to determine whether or not to create an asset, whether or not to open the asset in the collaborative surface, whether or not to edit the asset, and whether or not to respond in the conversational interface. In some aspects, a prompt might cause the generative response engine to both edit the asset and to provide a conversational response in the conversational interface. Many of these interactions are addressed below.

According to some examples, method 500 includes receiving an edit to the asset at block 508. For example, front end 102 illustrated in FIG. 1 may receive an edit to the asset. As noted above, this is at the option of the user. For example, if the asset is a draft email, the user account can modify portions of the email content prior to requesting feedback or additional modifications from the generative response engine. The first version of the asset that is provided to the generative response engine can be the most recent version of the asset displayed in the collaborative surface, i.e., the version of the asset containing the modifications made by the user account via the collaborative surface. In this way, the user and generative response engine can work collaboratively on the asset as if the user is working in real time with a human collaborator. When the user has edited the asset, the method 500 includes sending the edits to the asset to the system architecture server at block 510. For example, front end 102 illustrated in FIG. 1 may send the edits to the asset to system architecture server 120.

Edits made within front end 102 are sent to system architecture server 120, which maintains the asset. Front end 102 can receive edits and interactions with the asset, and render the asset from the copy of the asset at system architecture server 120. The version of the asset stored at system architecture server 120 consists of a series of transforms that represent actions and changes performed to the asset. A benefit of maintain the asset in this way is that it is easy to track changes to the asset and who made the changes. It also supports the ability to undo changes to the asset.

According to some examples, method 500 includes receiving a second prompt at block 512. For example, front end 102 illustrated in FIG. 1 may receive a second prompt. As illustrated in FIG. 5, the second prompt can be received independent of whether or not the user made any edits to the asset.

According to some examples, method 500 includes sending the second prompt and the current version of the asset at block 514. For example, front end 102 illustrated in FIG. 1 may send the second prompt and the current version of the asset. The sending of the current version of the asset is important for the generative response engine to learn the current state of the asset. This is how the generative response engine can learn about edits to the asset that the user might have made at block 508.

The current version of the asset is sent in a manner that is transparent to the user in a system message, which is sometimes referred to as a whisper message. A whisper message refers to private instructions or messages that are sent to guide the behavior of the assistant without being disclosed to the user. The whisper message is provided to the generative response engine along with the prompt, but unlike many other instructions and prompts provided to the generative response engine, the current version of the asset is not just appended to the prompt. Instead, any past versions of the asset are removed and replaced by the current version of the asset. This is done to manage the number of tokens in a prompt. If too many versions of the asset were provided to the generative response engine, the context window might get too large, and response times might become unreasonably long. Thus, front end 102 can manage the whisper message to only include the current version of the asset.

Using the whisper message, the generative response engine can infer that changes to the asset that it has not seen before were made by the user.

In some aspects, rather than provide the current version of the asset from the asset rendered in the front end, it can also be possible to provide the generative response engine with (or give the generative response engine access to) the transforms for the asset stored at system architecture server 120. This mechanism can have an advantage of providing the generative response engine with information about which entity made particular changes. This could be particularly useful when there are multiple users editing the asset in collaboration with the generative response engine.

According to some examples, at block 516, method 500 can include receiving, by the generative response engine, a second prompt and a current version of the asset. By way of example, at block 504, the generative response engine may have created an asset in response to the first prompt where the asset (e.g., a first version or current version of the asset) is displayed via the collaborative surface. The second prompt can contain an instruction for modifying the current version of the asset. In some examples, at least a portion of the current version of the asset may have been modified by a user account via the collaborative surface before providing the second prompt. For example, if the asset is a draft email, the user account can modify portions of the email content prior to requesting feedback or additional modifications from the generative response engine. The current version of the asset that is provided to the generative response engine can be the most recent version of the asset displayed in the collaborative surface, i.e., the version of the asset containing the modifications made by the user account via the collaborative surface. In this way, the user and generative response engine can work collaboratively on the current asset as if the user is working in real time with a human collaborator.

According to some examples, at block 518, method 500 can include modifying, by the generative response engine, the current version of the asset based on the instruction. For example, generative response engine 110 can generate tokens in response to the prompt to create an updated version of the asset or to update a portion of the asset. For example, the generative response engine can receive the second prompt, or a message history including both the first prompt and the second prompt, as well as the current version of the asset and can generate output including the updated version of the asset that is based on the current version of the asset and the second prompt.

According to some examples, at block 520, method 500 can include providing, to the front end, the updated version of the asset for display via the collaborative surface.

According to some examples, method 500 may include front end 102 illustrated in FIG. 1 presenting the updated version of the asset at block 522. In addition to presenting the updated version of the asset, front end 102 illustrated in FIG. 1 may send updates used to create the updated version to the system architecture server at block 524. If the generative response engine re-wrote the entire asset, front end 102 can send a transform to be recorded by system architecture server 120 reflecting this update. If the generative response engine revised a particular portion of the asset, front end 102 can send a transform to be recorded by system architecture server 120 reflecting this update. In this way, the edits or updates made by the generative response engine can be recorded in the version of the asset maintained by system architecture server 120.

The user can then further interact with the updated and now current version of the asset through the user account via the collaborative surface. For example, the user can further modify the updated/current version of the asset or can provide another prompt to the generative response engine to modify the updated/current version of the asset. In some examples, the front end can store the conversation history and a version update history at system architecture server 120. In some examples, block 512 through block 524 can be repeated any number of times such that the user and the generative response engine collaboratively modify the asset.

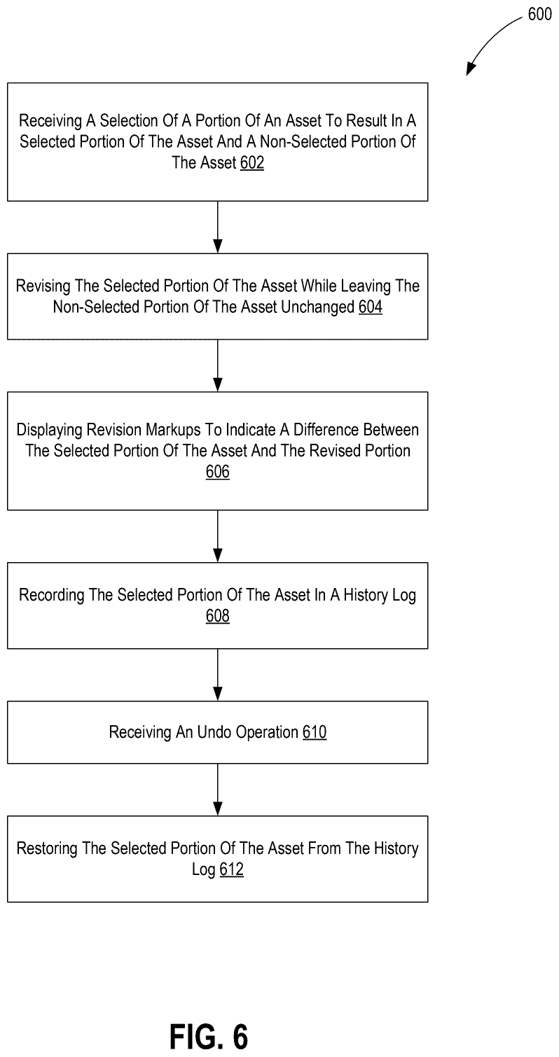

FIG. 6 illustrates example method 600 for selectively interacting with a portion of an asset by a generative response engine while leaving a non-selected portion of the asset unchanged, in accordance with some aspects of the present technology. Although method 600 depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

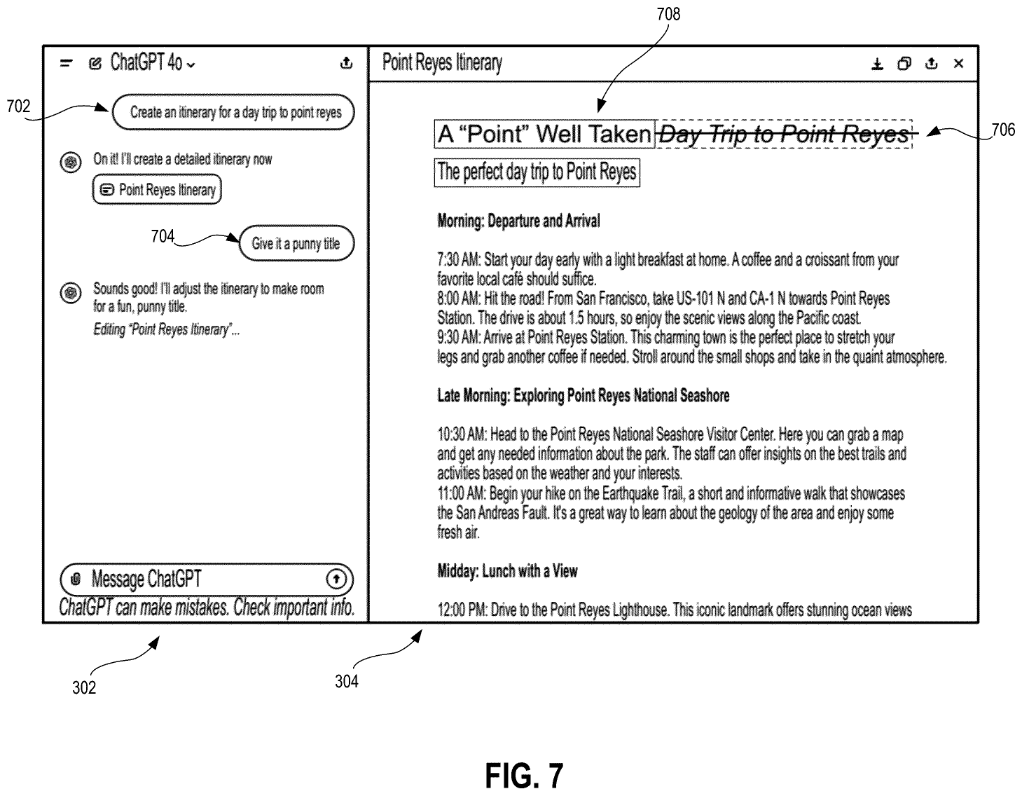

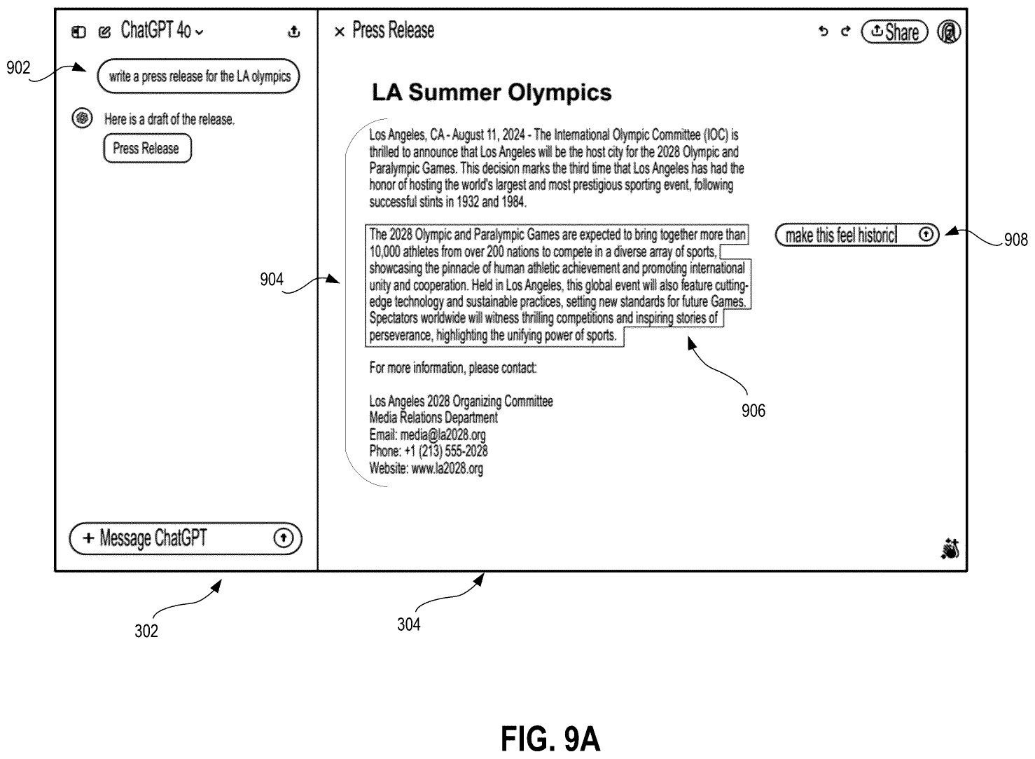

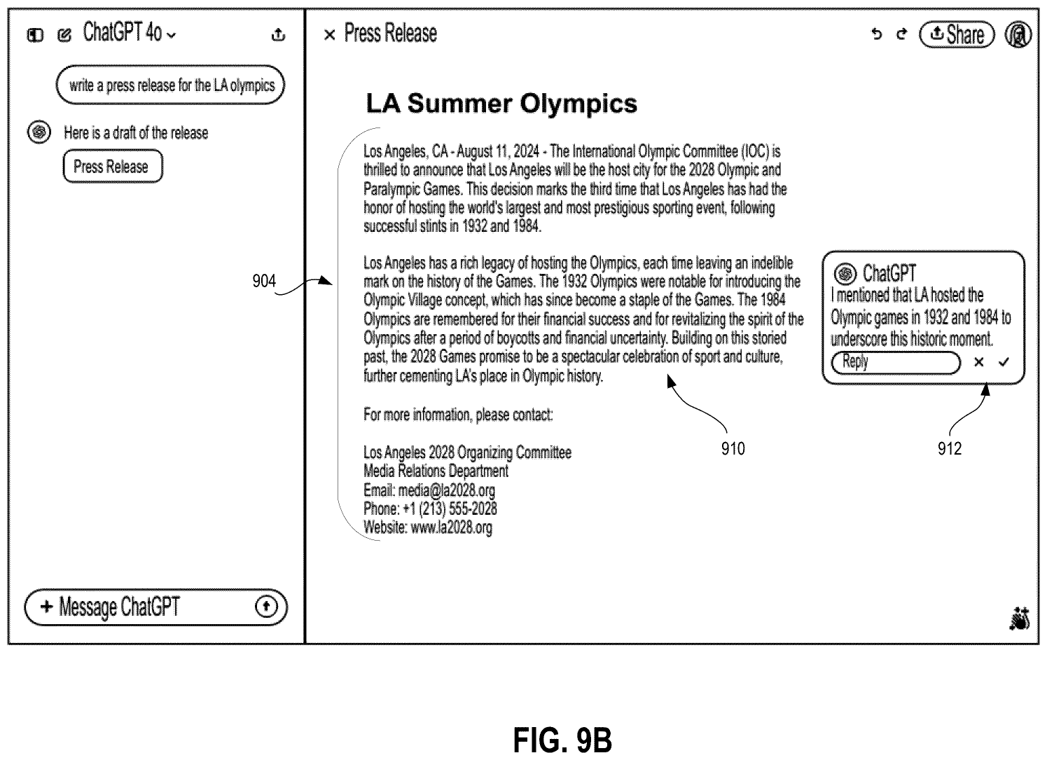

According to some examples, at block 602, method 600 includes receiving, from a user account, a selection of a portion of an asset displayed in a collaborative surface to result in a selected portion of the asset and a non-selected portion of the asset. For example, front end 102 illustrated in FIG. 1 may receive a selection of a portion of the asset to result in a selected portion of the asset and a non-selected portion of the asset. While all of the content of the asset is accessible to the generative response engine, the user may wish to focus the effort of the generative response engine on working with the selected portion of the asset. The selection of the portion of the asset can be the result of a reference to the selected portion of the asset (e.g., as described below with reference to FIG. 7) or highlighting the selected portion of the asset (e.g., as described below with reference to FIG. 9A).

According to some examples, at block 604, method 600 includes revising the selected portion of the asset while leaving the non-selected portion of the asset unchanged. For example, generative response engine 110 illustrated in FIG. 1 may revise the selected portion of the asset while leaving the non-selected portion of the asset unchanged. Generally, generative response engines interacting through a conversational interface will recreate all tokens in the asset it is asked to revise. However, when instructed to do so, the present technology primarily generates tokens to create a revised portion to replace the selected portion of the asset. This function can have important advantages. First, it is more efficient to mostly limit the tokens generated to tokens for the portions of asset that need to be revised, thereby using computing resources more efficiently. Also, limiting the tokens generated to tokens for the portions of the asset to be revised provides a better user experience because it can be frustrating to users when the generative response engine revises portions of a document other than a particular portion desired by the user.

Additionally, this functionality can enable the generative response engine to work with longer documents. Generative response engines commonly have token limitations and context limitations that can be mitigated due to only needing to revise the selected portion of the asset. When a document has more tokens than the generative response engine is configured to process, it can be helpful to provide snippets of the asset to provide context. In some examples, the document does not need to be provided in raw token form, such as when the generative response engine might first use another tool to create a more efficient representation of the asset. In some examples, portions of the asset that are more localized to the portion to be revised can be supplied in full. Regardless of what additional content or additional portions of the asset are provided to the generative response engine, the selected portion of the asset to be revised is the most important.

While generating new text to replace the selected portion of the asset is straightforward for the generative response engine, actually replacing the text in the asset with the new text can be a bit more complicated because the generative response engine needs to instruct the front end to manipulate a cursor to select text to be replaced and type or paste the new text. It is not always the case that a user will have used a cursor to highlight text that needs to be replaced. Sometimes the user will paste the text to be replaced in the conversational interface. Sometimes the user might refer to a paragraph or section of an asset in the conversational interface. Sometimes the user might refer to changes to be made in response to comments that the generative response engine has previously made in the asset. There can be other interaction paradigms too. Since it is not always the case that a user has already used a cursor to select the exact text to be replaced in an asset, the generative response engine needs a mechanism to tell the front end what text should be replaced and what should be added.

In some aspects, the generative response engine can create regular expressions (REGEX) patterns to identify strings of text that should be selected and replaced. The generation of the REGEX patterns with instructions to control the front end is another behavior that the generative response engine is post trained for, as will be addressed in greater detail below. More specifically, the generative response engine is trained to determine whether it should re-write the entire asset, or it should make targeted edits. For example, the generative response engine can be trained to select and edit multiple locations in the asset (e.g., in a find and replace operation, or to maintain consistency). In addition to generating the next text for the asset, the generative response engine will also output instructions to the front end to either replace the entire content of the asset or to replace portions matching a REGEX pattern provided by the generative response engine.

As an example, front end 102 can provide to the user interface displaying the asset to visually select the referenced portion of the asset, and to replace the visually selected portion of the asset with the response to the prompt. In some examples, front end 102 can generating, a RegEX string that instructs the user interface which portion of the asset to visually select. In some examples, generative response engine 110 streams characters in the RegEX string to the user interface, whereby the user interface can expand the visual selection of the referenced portion in response to receiving additional characters in the RegEX sting.

According to some examples, at block 606, method 600 can include displaying revision markups to indicate a difference between the selected portion of the asset and the revised portion. For example, front end 102 illustrated in FIG. 1 may display revision markups to indicate a difference between the selected portion of the asset and the revised portion. The revision markups can be generated using different methods. In some examples, the revision markups are the result of markup output by the generative response engine. More specifically, the generative response engine can understand that the user wants to be able to see what portion(s) of the asset is/are changed, and assuming the asset type is suitable for showing revisions, the generative response engine can output tokens showing the revisions (e.g., HTML formatting underlining, revisions, highlights, etc.). In some examples, the revision markups can be created by the front end. As will be addressed below, the front end can work with collaborative asset service 140 to display a history log of changes to the asset. The front end can use this history log to compare the selected portion of the asset recorded in the history log with the revised portion of the asset and generate the revision markups. FIG. 7, described below, shows an example of the revision markups.

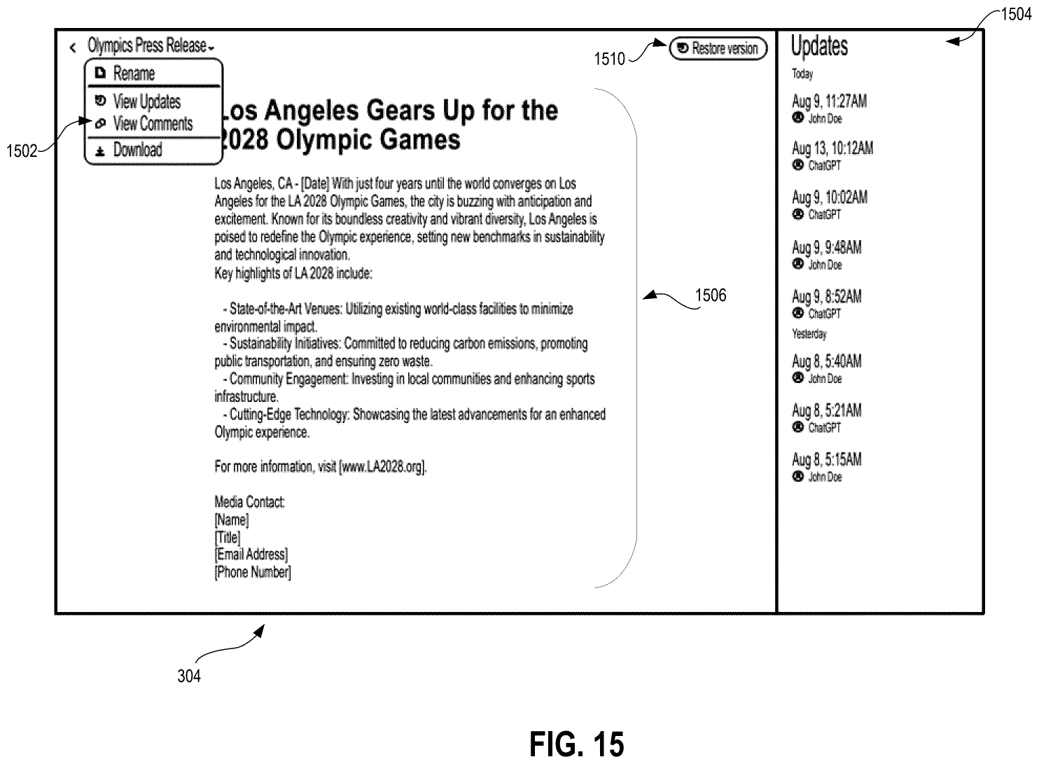

According to some examples, at block 608, method 600 can include recording the selected portion of the asset in a history log. For example, front end 102 illustrated in FIG. 1 may record the selected portion of the asset in a history log. FIG. 15, described below, illustrates an example of a history log.

According to some examples, at block 610, method 600 can include receiving an undo operation. For example, front end 102 illustrated in FIG. 1 may receive an undo operation indicating the user account wants to revert the current version of the asset, or of the portion of the asset, to a previous version of the asset or a previous version of the portion of the asset, thereby removing the modifications made to the asset by the generative response engine in response to a prior prompt.

According to some examples, at block 612, method 600 can include restoring the selected portion of the asset from the history log. For example, front end 102 illustrated in FIG. 1 may restore the selected portion of the asset from the history log. In some aspects, undoing a change can be handled by deleting a transform in the list of transforms representing the asset at collaborative asset service 140, or can be handled by adding a new transform that is the opposite of the transform(s) that need to be undone. The front end can then re-render the asset based on the updated list of transforms making up the asset.

In another example, if a user account requests (e.g., via prompt to the generative response engine) a revision history of an asset, the generative response engine can receive the chat history and a most recent version of the asset as one or more whisper messages from the front end. The generative response engine can be trained to determine a revision history of the asset based on the prompts and responses in the chat history and on the current version of the asset. The determined revision history can be displayed to the user via the collaborative surface with visual elements to indicate changes from the original version of the asset.

In another example of selectively generating output for a portion of an asset, generative response engine 110 can receive a prompt referring to a portion of the asset and requesting a revision to the portion of the asset. The prompt can include a referenced portion of the asset and implies an unreferenced portion of the asset. The referenced portion of the asset can be referenced through a selection of the referenced portion of the asset in a user interface displaying the asset. As an example, a user can highlight a word or phrase in content of the asset. The prompt may instruct generative response engine 110 to replace the word or phrase. Generative response engine 110 can determine, based on the prompt, an intent of the user account to replace each instance of the word or phrase in the content of the asset, rather than just the highlighted or selected instance. Generative response engine 110 can determine that each instance of the word or phrase is a referenced portion of the asset.

In this example, generative response engine 110 can generate a response to the prompt, where generated tokens are intended to replace the referenced portion of the asset, but not the unreferenced portion of the asset. For example, a response could be a replacement term for the word or phrase. Generative response engine can apply the response to the asset by replacing the referenced portion of the asset (e.g., replacing each instance of the word or phrase with the replacement term).

FIG. 7 illustrates an example of a user interface wherein a portion of the asset is selected by reference to the asset in accordance with some aspects of the present technology. While FIG. 7 illustrates a particular user interface, the present technology should not be considered limited to use with the particular user interface. Rather, the user interface illustrated in FIG. 7 is provided to illustrate example options and example functionality provided by the present technology.

As illustrated in FIG. 7, first prompt 702 received in conversational interface 302 may cause a generative response engine to output an itinerary. As discussed above, the generative response engine may determine an intent of the user account to work collaboratively on the asset based on the asset type being an itinerary (e.g., a text document). Thus, the generative response engine may cause the front end to provide the itinerary in collaborative surface 304 of the user interface.

In this example, the user account has provided second prompt 704 to instruct the generative response engine to give the asset (e.g., the itinerary) “a punny title.” Based on this second prompt 704, the generative response engine understands that the user account is referring to the title of the asset (e.g., “Day Trip to Point Reyes”), and thus, the title becomes selected portion of the asset 706 for which the generative response engine should generate revised content.

In response to second prompt 704, the generative response engine can output a revised title, “A ‘Point’ Well Taken.” In some examples, the revision can be shown using revision markup or the generative response engine can be prompted to provide the response in a revision markup. For example, collaborative surface 304 can display the title of the original asset in strikethrough, while displaying the title created in response to second prompt 704 (e.g., the title replacing the original title) with an underline. Accordingly, a user can view conversational interface 302 and collaborative surface 304 to easily identify changes made to the original asset provided in response to first prompt 702.

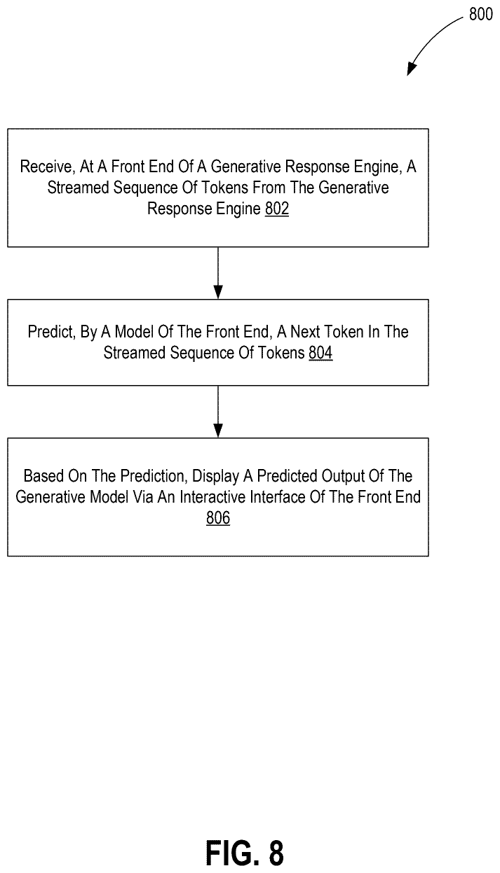

FIG. 8 illustrates example method 800 for rendering the output of a generative response engine by a front end of the generative response engine in accordance with some aspects of the present technology. Although the example method 800 depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

As an example, the generative response engine can receive a prompt to rewrite a portion of an asset displayed in a collaborative surface of the front end. The generative response engine can output the rewritten portion of the asset as a series of tokens, which are streamed to the front end, such that the front end sequentially receives the tokens output by the generative response engine. In order to provide a good user experience that allows the user to know that the generative response engine is performing the task, the front end can start to display the tokens as they are received. This is better than waiting for the generative response engine to produce all the tokens before rendering them because it can sometimes take many seconds or even a few minutes before the generative response engine has completed its output.

Rendering the text as the tokens are received isn't too much of a challenge, but the replacing of text is harder. The replacement of text requires the creation of a REGEX pattern, as addressed above. The challenge with the REGEX pattern is that the front end cannot know what matches the REGEX pattern until it has received the whole REGEX pattern. As such the front end includes logic to start to display the selection of the portion of the asset matching the REGEX pattern until it receives the entire REGEX pattern and can learn the exact portion of the asset to be replaced.

The example of the REGEX pattern is just one example of a challenge that affects other portions of the asset. More specifically, tool calls by the generative response engine are a challenge. The creation of a REGEX pattern is an example of a tool call (tool 130). While tokens are streamed sequentially, tools introduce a unique challenge. Unlike raw text, tools require the model to send back a complete data structure, often in the form of a JSON string. Until the data structure is complete, the system cannot parse or use it. For instance, if the model is generating a JSON object to create a document, the partial object cannot be used until all tokens have been received. To address this, the front end implements a system for incremental parsing. By predicting the final state of the data structure, the front end can provide an optimistic preview of the output. This includes dynamically updating the user interface to show changes in real-time, such as text being typed or images being constructed.

Method 800 improves user experience by providing a rendering of predicted output via the collaborative surface. Thus, the user is provided a preview of the output that is continuously updated until the complete output is received by the front end from the generative response engine. In examples in which the asset being modified or provided is text, the rendering may appear as if the output is being typed in real time or near-real time. If the asset is an image or graphic, individual elements forming the image may appear sequentially. The rendering of the predicted output improves the user experience, particularly because it provides the predicted output, rather than the user experiencing a lag while waiting for the full output to be provided.

According to some examples, at block 802, method 800 can include receiving, at a front end of a generative response engine (e.g., generative response engine 110 described with reference to FIG. 1), a streamed sequence of tokens from the generative response engine. As discussed above, the streamed sequence of tokens can form a segment of executable code. The full executable code may not be able to be parsed and rendered by the front end until the full sequence of output tokens is received at the front end.

To mitigate this lag in rendering the output, according to some examples, at block 804, method 800 can include predicting, by a model of the front end, a next token in the streamed sequence of tokens. For example, the model of the front end can be a machine learning model trained to resolve ambiguity as to the next token in the streamed sequence of tokens, such that the model can generate a prediction of the full output of the generative response engine (e.g., the model can predict a complete JSON string or JSON object that can be parsed and rendered by the front end). This capability enables the front end to offer incremental feedback to the user, visually illustrating the evolution of the data structure or text being created.

According to some examples, at block 806, method 800 can include, based on the prediction, displaying a predicted output of the generative model via a collaborative surface of the front end. As discussed above, method 800 can be performed as subsequent tokens are received such that the output of the generative response engine gradually appears in the collaborative surface. The ability to render intermediate states and provide real-time feedback greatly enhances the user experience, allowing the user to interact seamlessly with the generative response engine while changes unfold in a visually coherent manner.

FIG. 9A and FIG. 9B illustrate an example of a user interface in which a portion of the asset is selected and modified in accordance with some aspects of the present technology. While FIG. 9A and FIG. 9B illustrate a particular user interface, the present technology should not be considered limited to use with the particular user interface. Rather, the user interface illustrated in FIG. 9A and FIG. 9B is provided to illustrate example options and example functionality provided by the present technology.

FIG. 9A and FIG. 9B illustrate an example in which a user can generate an asset via the conversational interface 302 of a user interface and can revise the asset by providing a prompt for a selected portion of the asset via collaborative surface 304. This example should be considered non-limiting and illustrates that prompts can be provided to the generative response engine both through conversational interface 302 and collaborative surface 304.

As illustrated in FIG. 9A, asset 904 is generated in response to first prompt 902 and is displayed in collaborative surface 304. A user account can select a portion of asset 904 (e.g., the selected portion of asset 906) for further modification by the generative response engine. For example, the user may be satisfied with the rest of the content of asset 904, but may wish to only further modify the selected portion of the asset 906. In response to receiving a selection of a portion of asset 904, the front end may provide a pop-up input box 908 through which the user account can provide a prompt for modifying the selected portion of the asset 906. For example, the user account can prompt the generative response engine to make selected portion of the asset 906 “feel historic.” In other words, the user account may only intend for the generative response engine to revise selected portion of the asset 906 and to leave the remainder of the content of the asset as-is.

The generative response engine can receive first prompt 902 and selected portion of the asset 906 as input. In some examples, the full text of asset 904 is not provided as input, and only the contents of the selected portion of asset 906 are provided as input in addition to the first prompt 902. In another example, the full text of asset 904 can be provided as input with data indicating the selected portion of the asset 906. The generative response engine can then output tokens associated with the selected portion of the asset 906 for rendering by the front end.

As illustrated in FIG. 9B, the generative response engine has revised the selected portion of the asset 906 as instructed by the second prompt provided via input box 908. For example, FIG. 9B shows revised selected portion 910 along with response 912 from the generative response engine indicating to the user that it has completed the task indicated by the prompt. As shown in FIG. 9B, response 912 can be provided via collaborative surface 304 to appear as a comment bubble or pop-up near the revised selected portion 910 such that response 912 can be visually associated with revised selected portion 910 of asset 904.

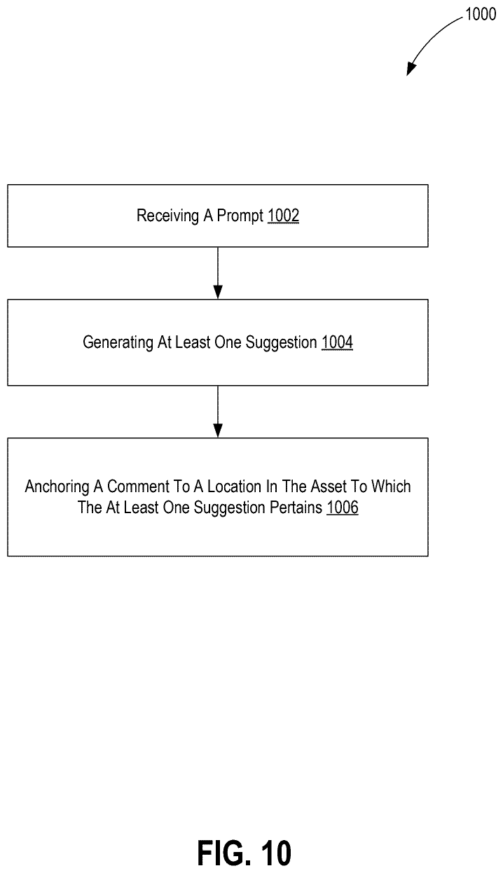

FIG. 10 illustrates an example method 1000 for anchoring a comment provided by the generative response engine to a relevant portion of an asset displayed in a collaborative surface, in accordance with some aspects of the present technology. Although the example method 1000 depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, at block 1002, method 1000 can include receiving a prompt. For example, generative response engine 110 illustrated in FIG. 1 may receive prompt input via a conversational interface or a collaborative surface. The prompt may instruct the generative response engine to make suggestions on the asset or on a portion of the asset. In some examples, the prompt can be a common prompt that can be easily selected within collaborative surface 304 user interface.

According to some examples, at block 1004, method 1000 can include generating at least one suggestion. For example, the generative response engine 110 illustrated in FIG. 1 may generate at least one suggestion. The suggestion can be generated by the generative response engine in response to the prompt. For example, a user account can provide a prompt requesting feedback from the generative response engine on the tone of the asset or a portion of the asset. The response from the generative response engine can be provided as a suggestion for modifying the asset or a portion of the asset along with text that is effective to cause front end 102 to display the suggestion as a comment in the asset.

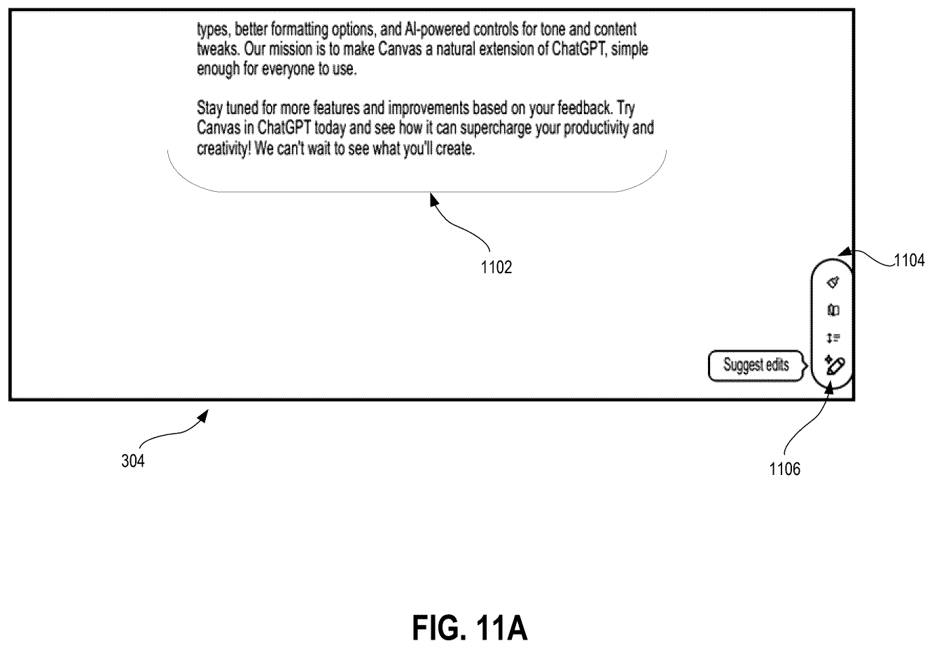

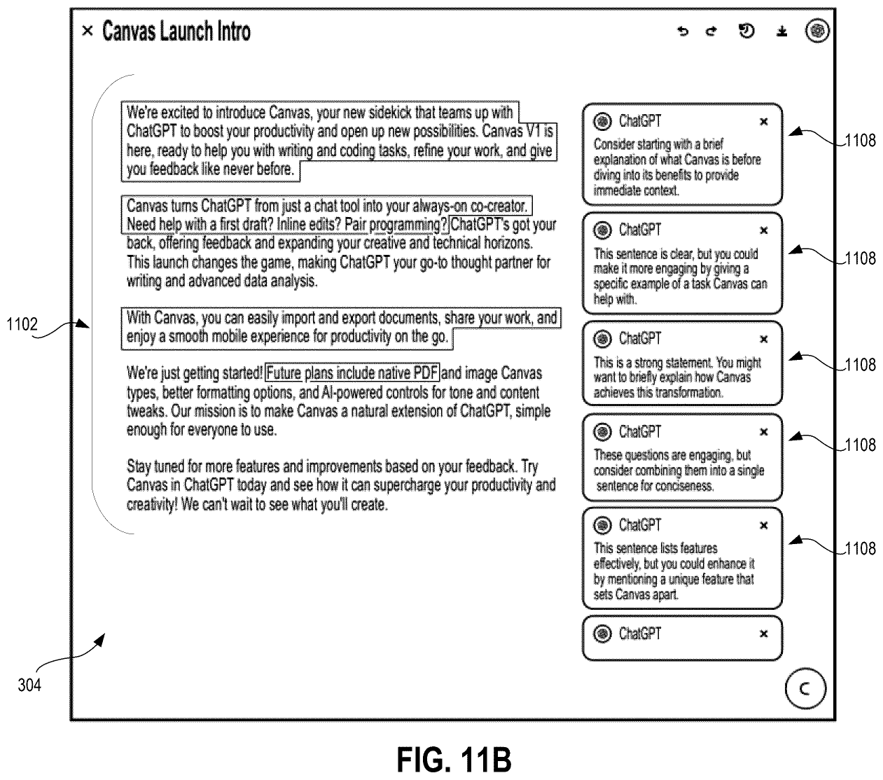

According to some examples, at block 1006, method 1000 can include anchoring a comment to a location in the asset to which the suggestion pertains. For example, front end 102 illustrated in FIG. 1 may anchor the comment to the location in the asset to which the suggestion pertains, which is illustrated in FIG. 11B and discussed below. The comment can also include the suggestion provided by the generative response engine with the anchored comment bubble. The comment can be displayed in the asset as instructed by the output of generative response engine 110.

To achieve this functionality, the generative response engine may have been trained using datasets containing annotated examples of text or assets with corresponding suggestions and their anchored locations. This training allows the engine to learn patterns in text and context that indicate where a comment might be most relevant or helpful. Additionally, the training process may involve reinforcement learning where feedback from users is used to refine the engine's ability to identify optimal locations for comments.

Furthermore, to instruct the front end to insert comments, the generative response engine communicates with the collaborative surface interface through defined protocols. Front end 102 may receive specific instructions on how to render the comment, such as the precise coordinates or contextual markers within the asset. This ensures that the comment appears at the intended location, providing clarity and improving the user's interaction with the collaborative surface.

FIG. 11A and FIG. 11B illustrate interactions of a user account with portions of an asset 1102 displayed in a collaborative surface using a shortcut to a common prompt in accordance with some aspects of the present technology. While FIG. 11A and FIG. 11B illustrate a particular user interface, the present technology should not be considered limited to use with the particular user interface. Rather, the user interface illustrated in FIG. 11A and FIG. 11B is provided to illustrate example options and example functionality provided by the present technology.

FIG. 11A illustrates asset 1102 in collaborative surface 304 (the conversational interface is not shown). As addressed above, some asset types can be presented in collaborative surface 304 with properties associated with the asset type, which, in FIG. 11A, is a document. The document asset type can be displayed with menu 1104 of selectable icons (e.g., icon 1106) that can function as shortcuts to common prompts. In FIG. 11A, icon 1106 can be selected to generate and provide a prompt to the generative response engine to ‘suggest edits’ to asset 1102. In other examples, the user account can request that the generative response engine suggest edits to asset 1102 via conversational interface 302.

Additional or alternative shortcuts can be provided in menu 1104 when the asset displayed in the collaborative surface 1104 is code. A shortcut included in menu 1104 can be a shortcut for “Code review,” which prompts the generative response engine 110 to search for bugs and opportunities to improve the code. For example, the generative response engine 110 can identify ways that code performance or code structure could be improved. Leave as few comments as possible, but add more comments if the text is long. In some examples, the generative response engine 110 can generate one or more comments anchored to lines of the code displaying suggestions for improving the code. A user can select to apply one or more of the suggestions. In another example a shortcut can be “Add comments,” which can cause the generative response engine 110 to add inline code comments to explain the code, including parts of the code that are more complex. Another shortcut included in menu 1104 can be “Add logs,” which can prompt generative response engine 110 to insert logs/print statements in the code that will help debug its behavior when the code is run. Another shortcut can be “Fix bugs,” which can prompt generative response engine 110 to find bugs in the code and rewrite the code to fix the bugs. If there are no bugs, generative response engine 110 can reply that no bugs were found. A shortcut for “Port to a language,” can prompt generative response engine 110 to create a new document that rewrites the code in a different programming language specified by the user account.

Additional document shortcuts can include, for example, “Suggest edits,” which prompts generative response engine 110 to generate suggested edits that would improve the text of the asset displayed in collaborative surface 304. Suggestions can be content to add or remove, places to rephrase so that the text flows more smoothly, or ways to reorganize ideas in the text to be more effective. Another shortcut can be “Add emojis,” which can prompt generative response engine 110 to replace as many words as possible with emojis. “Add final polish,” can prompt generative response engine 110 to regenerate the text of the asset to include revisions to correct any grammatical errors or to apply a particular style to the text. In some examples, for a long text, generative response engine 110 can generate titles or headings for one or more sections of the text to improve readability. “Reading level,” can prompt generative response engine 110 to rewrite the text at a reading level specified by the user account via the conversation interface 302 or by selecting a shortcut icon from menu 1104 in collaborative surface 304. Reading levels can be, for example, “a 5^{th} grade reading level,” “an academic level,” “a simplified reading level,” and the like. Another shortcut can, for example, prompt generative response engine 110 to re-generate the asset and to increase the word or character count of the asset by an amount specified by the user account.

While FIG. 11A illustrates a document asset type, other asset types are supported, and when another asset type is displayed, menu 1104 can be updated with selectable icons that are relevant to that asset type.

In FIG. 11B, the collaborative surface 304 illustrates the result of the selection of the ‘suggest edits’ common prompt (e.g., icon 1106). More specifically, asset 1102 is shown with anchored comments 1108 anchored to the portions of asset 1102 to which they pertain. In this way, the generative response engine can act like a document collaborator commenting on a shared asset. In some examples, the output of the generative response engine can cause the front end to render a version of asset 1102 in collaborative surface 304 highlighting the portions of the asset to which the respective anchored comment 1108 applies.

In some examples, anchored comments 1108 can be selected by the user account via the user interface and be applied to asset 1102. For example, the front end can receive a selection of an anchored comment 1108 and generate a prompt to the generative response engine based on the comment. The prompt and the current version of asset 1102 can be provided to the generative response engine as input to cause the generative response engine to output a new version of asset 1102 with the suggestions from the selected comment applied to the content of the asset.

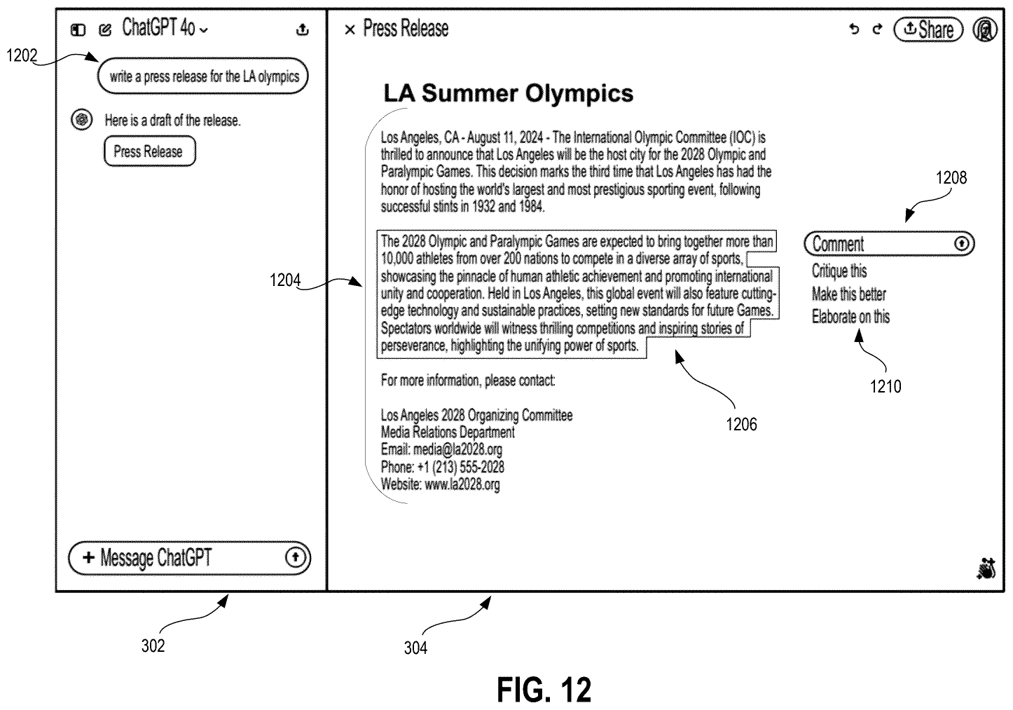

FIG. 12 illustrates another example of common prompts available via collaborative surface 304, in accordance with some aspects of the present technology. While FIG. 12 illustrates a particular user interface, the present technology should not be considered limited to use with the particular user interface. Rather, the user interface illustrated in FIG. 12 is provided to illustrate example options and example functionality provided by the present technology.

FIG. 12 shows asset 1204 generated by the generative response engine in response to prompt 1202 and displayed in collaborative surface 304. Using collaborative surface 304, a user account can select a portion of the asset 1206. Once the user account has selected the portion of the asset 1206, collaborative surface 304 may display comment window 1208. Comment window 1208 can be used to receive input from a user account associated with a prompt to be applied to the selected portion of the asset 1206.

In some examples, in connection with the selection of the portion of the asset 1206, a user can hover over comment window 1208 or click into comment window 1208 to cause collaborative surface 304 to display menu 1210 including shortcuts to common prompts. Menu 1210 of shortcuts to common prompts can facilitate interaction with the generative response engine, as well as suggest helpful prompts to the user. In some examples, the shortcuts included in menu 1210 may be dynamic and may change depending on the content of the selected portion of the asset.

In another example, the shortcuts may be different for different asset types. For example, if collaborative surface 304 is functioning as a code editor (e.g., rather than a document editor), a menu of shortcuts for a highlighted code portion may include options such as “debug this” or “create documentation” or “comment this section” (e.g., prompting the generative response engine to provide in-line comments in the selected code portion).

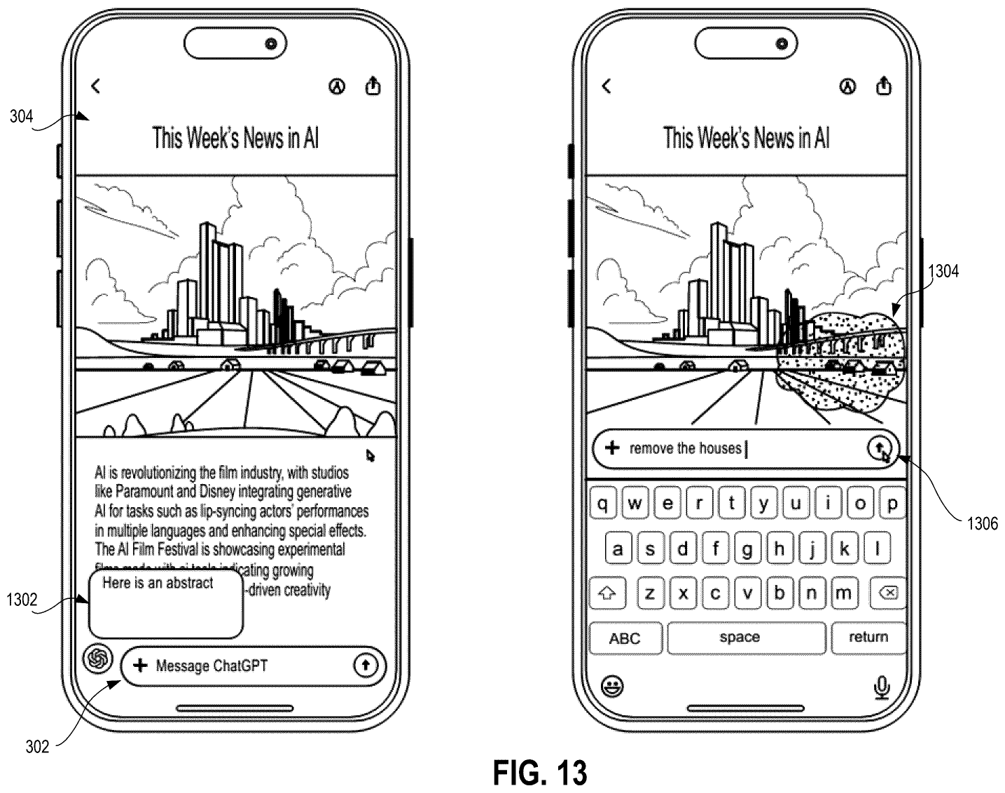

FIG. 13 illustrates a mobile user interface in accordance with some aspects of the present technology. While FIG. 13 illustrates a particular user interface, the present technology should not be considered limited to use with the particular user interface. Rather, the user interface illustrated in FIG. 13 is provided to illustrate example options and example functionality provided by the present technology.

The smaller size of a display of a mobile device means that a mobile experience needs to be different than the display of a web browser on a larger display of a tablet or personal computer, but the same interaction paradigm addressed herein is still desired. FIG. 13 illustrates an asset (e.g., a portion of an article including a graphic and an abstract) displayed, substantially covering the screen, except for an input portion that can be displayed as overlay 1302 to collaborative surface 304 displaying the asset. In this way, the inputs can be separated from the asset. Conversational interface 302 can be displayed along the bottom of the screen.

As in the larger display examples, the user account can still directly interact with the asset. For example, a user can provide a selection of region 1304 of the image content of the asset. In response to receiving the selection of the area or region 1304, collaborative surface 304 can provide input window 1306 through which a user can provide a prompt associated with the selected region 1304 of the asset. For example, the prompt can be to remove images of houses from the selected region 1304. The generative response engine can understand the relationship between the prompt and the selected portion of the asset to generate a revised version of the asset with no houses pictured in the selected region 1304.

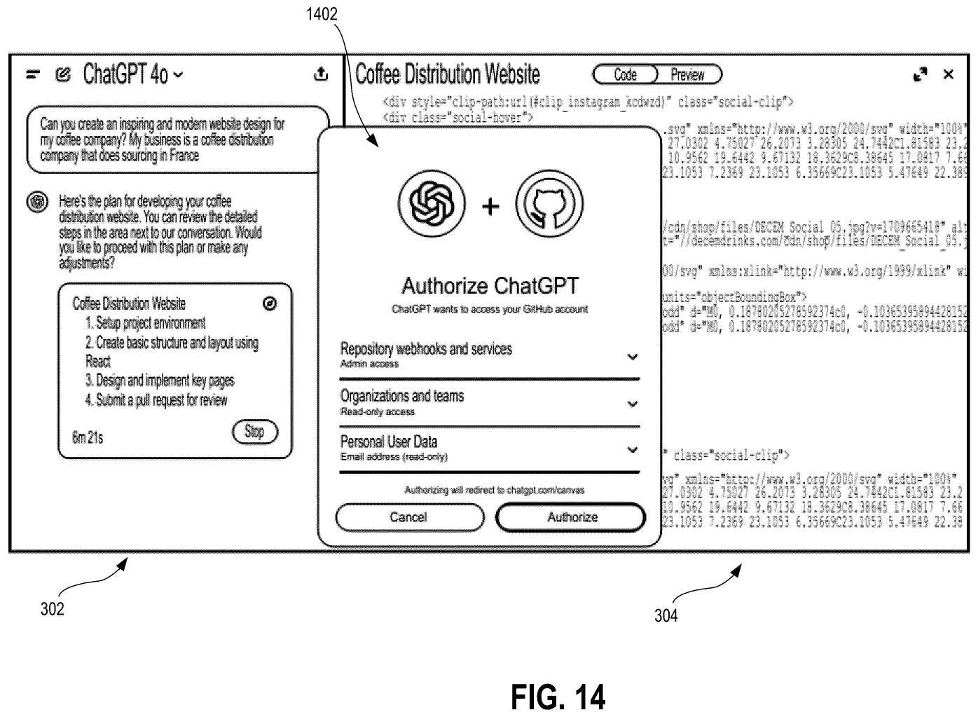

FIG. 14 illustrates that the present technology can be integrated with third-party applications, according to some aspects of the present technology. For example, a user account can authorize the collaborative surface (e.g., the front end) to have access to data associated with a third-party application.

In a non-limiting example, the front end can be authorized (e.g., via window 1402) to access a user's code repository data. In some examples, this can enable the front end to load code packages from the user's code repository for editing or collaboration with the generative response engine through collaborative surface 304. In other examples, the user account can directly save work product created with the generative response engine directly to the user's code repository from collaborative surface 304.

FIG. 15 illustrates an interface displaying history log 1504 for viewing revisions to asset 1506 made using the generative response engine, in accordance with some aspects of the present technology.

Via collaborative surface 304, a user can select menu option 1502 to “View Updates” (e.g., to view a revision history of asset 1506). In some examples, the user can right-click to display menu 1508 including the “View Updates” option 1502. Upon receipt of the “View Updates” option 1502, the front end can retrieve and display history log 1504. History log 1504 can list each time a new version of asset 1506 was generated or a portion of the asset was modified. In some examples, history log 1504 can include a timestamp of the creation of each version and the entity that created the version (e.g., the user or the generative response engine). Thus, a user can review changes made to asset 1506 by both themselves and the generative response engine.

As discussed above, in some examples, the front end stores the history log. In other examples, the history log can be generated based transforms stored in collaborative asset service 140, which maintains the asset that is rendered by front end 102. In other examples, not shown, history log 1504 can also include an indication of the type of modification (e.g., revision, deletion, insertion, comment, etc.) or a description of the modification of asset 1506.

In some examples, the user account can highlight or otherwise select a version from history log 1504 and click or select button 1510 to restore the selected version of the document. In certain examples, the selected version can be generated from the current version of the asset by reversing the modifications made at times after the selected version was created. In another example, the front end can render the selected version from collaborative asset service 140 by rendering the asset without applying revisions that were applied after the selected version or revision in history log 1504. In another example, the generative response engine can receive the chat history from the most recent message to the time of the selected version and can re-generate the selected version from the current version of the asset.

In another example, not shown in FIG. 15, history log 1504 can include a detailed list of modifications made to asset 1506 by both the user account and the generative response engine. For example, the list can include insertions, deletions, content revisions, etc. From the history log, the user account can select one or more modifications to asset 1506 to undo.

In some examples, an expanded user experience can be provided by using speech to provide the conversational interface. In such an example, the collaborative surface can display an animation or interactive asset, and the generative response engine can communicate to the user account using speech. The speech can be reactive to inputs provided into the collaborative surface. For example, the collaborative surface can include an interactive lesson, and the speech can be generated to explain lesson contents to the user.

In some examples, the present technology can integrate internet browsing capabilities of a generative response engine with the conversational interface and the collaborative surface. The generative response engine can access and utilize external data sources in response to user prompts in the conversational interface, enabling real-time fact-checking, asset revision, and generation of an asset in the collaborative surface. The present technology can adapt the user interface to display search results in the conversational interface and generate or modify an asset in the collaborative surface based on user interactions.

The user can provide a prompt through the conversational interface, which initiates a search for relevant information online. For example, the user may enter a prompt requesting the generation of an asset related to “recent advancements in quantum computing.” The generative response engine analyzes the prompt, initiates an internet search, and retrieves real-time search results, which are then displayed within the conversational interface. The user can review the results (or instruct the generative response engine to review the results and select relevant sources), select relevant articles or data sources, and instruct the generative response engine to fact-check or revise the generated asset based on the selected information.

Once the user or the generative response engine has selected specific search results, the generative response engine analyzes the asset and compares it with the generated asset. For example, the generative response engine may revise a portion of the generated asset to include references to newly discovered quantum algorithms or advancements mentioned in the selected articles. The generative response engine automatically fact-checks its previous output against the newly retrieved data, ensuring the accuracy of the generated asset. Any revisions are reflected within the dedicated collaborative surface, providing the user with an asset having updated content.

Furthermore, the present technology supports asset creation based on external data sources. Upon a user account's instruction, the generative response engine can generate entirely new sections of content. For instance, in response to a user request to “add a section on the impact of quantum computing on cryptography,” the generative response engine may search for and retrieve recent articles discussing this subject. The engine then synthesizes the data and creates a new asset or content section in the dedicated collaborative surface, incorporating the retrieved information while citing the relevant sources.

In addition, the user account may interact with the system iteratively to refine an asset or a portion of an asset. For example, the user may instruct the system to emphasize specific information from a selected article. The generative response engine responds by revising the asset in the collaborative surface, ensuring that the highlighted points are incorporated as directed by the user.

In some examples, the present technology can enable collaborative asset creation and editing through the integration of a generative response engine with both a conversational interface and a dedicated collaborative surface. The asset or content within the collaborative surface can be shared among multiple human user accounts, each of which may interact with the asset and provide input via a combination of comment bubbles anchored to the asset and the conversational interface. The generative response engine is adapted to handle revisions based on these interactions, either through a shared instance of the generative response engine or through personalized, fine-tuned instances of the generative response engine tailored to individual users.

In an example, the shared content in the content frame is associated with a single instance of the generative response engine. This shared instance is linked to the document, allowing it to receive and process input from multiple user accounts that have access to the document. User accounts can provide feedback or suggestions by leaving comment bubbles in the content frame or interacting with the conversational interface, asking for specific revisions, clarifications, or new content to be generated.

For example, if a shared document is being collaboratively edited by a team, one user might leave a comment bubble asking, “Can you expand this section on market trends?” The shared instance of the generative response engine processes this request and automatically revises the asset within the document, inserting additional information or expanding the existing text. Another user might use the conversational interface to ask, “Please rephrase this paragraph for clarity,” and the shared instance of the generative response engine would revise the text, accordingly, incorporating the feedback into the shared document.

The shared instance of the generative response engine is designed to handle multiple inputs from different users and ensure consistency and cohesion across revisions. In cases where conflicting input is received, the engine can either prompt the users for clarification or suggest compromise edits, ensuring that the document remains a collaborative and coherent piece of work.

In another example, the user accounts can have a personalized instance of the generative response engine that is fine-tuned to their specific preferences, expertise, and history of interaction. These personalized instances act as individual virtual assistants, responding to prompts and making revisions based on the respective user's distinct style, preferences, and learned behavior.

Multiple users can collaboratively work on the same shared content, but the respective user's interaction with the asset is mediated by their respective personalized instance of the generative response engine. The personalized instances understand and adapts to its user's specific needs. For example, a marketing expert may have a fine-tuned generative response engine that prioritizes persuasive language and customer insights, while a technical expert may have an engine instance that emphasizes technical accuracy and clarity.

When a user provides a prompt via comment bubbles or the conversational interface, their personalized instance of the generative response engine processes the request and revises the asset in the shared document accordingly. For example, User A might request, “Add more technical detail to this section on product specifications,” while User B might ask, “Simplify this paragraph for broader understanding.” The respective generative response engine instances of User A and User B will each make revisions based on their users' preferences, resulting in tailored asset contributions. The system ensures that the personalized revisions are reflected in the shared document, allowing for a seamless integration of different styles and expertise.

The present technology can be designed to facilitate collaborative editing by coordinating the input and actions of multiple personalized generative response engine instances. To maintain coherence in the shared document, the present technology can employ conflict-resolution algorithms that handle potentially contradictory revisions from different user accounts. For example, if User A's instance of the generative response engine rewrites a section for technical accuracy while User B's instance simplifies the same section, the system can either combine the edits or request clarification from the users involved, ensuring the document evolves in a cohesive and logical manner.

Moreover, the system allows users to track and manage revisions through version control mechanisms. Each revision made by a generative response engine instance is logged and associated with the user account responsible for the change. This provides transparency in collaborative projects, enabling users to see who has made what revisions and how the generative response engine has contributed to the shared asset. Users can also revert to previous versions of the document if necessary, ensuring that the editing process remains flexible.

In some examples, the generative response engine has been post-trained to determine to trigger the collaborative surface of the front end based on the context indicating an intent of a user account to collaborate with the generative response engine on the asset. The post-training can include, in some aspects, training the generative response engine on computer-generated synthetic data using one or more unsupervised learning techniques. For example, a language model can be used to generate prompts that imply or explicitly state that a user desires to work on a document. In particular, the language model can be asked to generate prompts that exemplify certain qualities that might correspond to launching the collaborative surface. These prompts can be scored by a rewards model for quality, and the top-quality prompts can be used as positive examples of prompts where the generative response engine should launch the collaborative surface. The same process can be used for negative examples of prompts that might refer to a document or short text, but for which a collaborative surface should not be launched. Thus, in some examples, the generative response engine can be post-trained without human intervention (e.g., without human-labelled data or human supervision).

The post-training can cause the generative response engine to recognize contexts contained in or determined from prompts provided to the generative response engine from the user account that are indicative of an intent, of the user account, to collaborate with the generative response engine on an asset. If a prompt or prompts indicate an intent to collaborate, the generative response engine can trigger the front end to open the collaborative surface. In some examples, the generative response engine can be post-trained to recognize scenarios in which the collaborative surface would be efficient for displaying output in response to a prompt. For example, the generative response engine can be post-trained to recognize certain content types or asset types that are better displayed via the collaborative surface. These types of content or assets may be large format (e.g., blocks of text, tables, or images) that are more easily viewed in the larger collaborative surface window.

The generative response engine can also be trained in a similar manner for various specific behaviors such as to determine when to replace a portion of the asset and when to re-write the entire asset, and where to locate comments in the asset too.

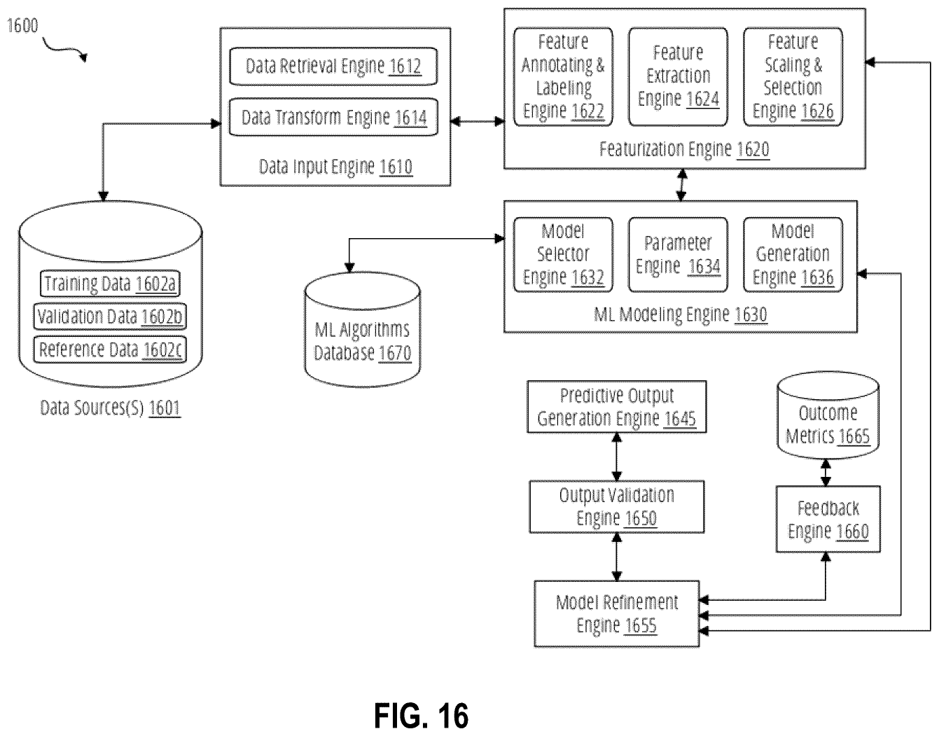

FIG. 16 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 1600 may include data input engine 1610 that can further include data retrieval engine 1612 and data transform engine 1614. Data retrieval engine 1612 may be configured to access, interpret, request, or receive data, which may be adjusted, reformatted, or changed (e.g., to be interpretable by another engine, such as data input engine 1610). For example, data retrieval engine 1612 may request data from a remote source using an API. Data input engine 1610 may be configured to access, interpret, request, format, re-format, or receive input data from data sources(s) 1601. For example, data input engine 1610 may be configured to use data transform engine 1614 to execute a re-configuration or other change to data, such as a data dimension reduction. In some aspects, data sources(s) 1601 may be associated with a single entity (e.g., organization) or with multiple entities. Data sources(s) 1601 may include one or more of training data 1602a (e.g., input data to feed a machine learning model as part of one or more training processes), validation data 1602b (e.g., data against which at least one processor may compare model output with, such as to determine model output quality), and/or reference data 1602c. In some aspects, data input engine 1610 can be implemented using at least one computing device. For example, data from data sources(s) 1601 can be obtained through one or more I/O devices and/or network interfaces. Further, the data may be stored (e.g., during execution of one or more operations) in a suitable storage or system memory. Data input engine 1610 may also be configured to interact with a data storage, which may be implemented on a computing device that stores data in storage or system memory.

System 1600 may include featurization engine 1620. Featurization engine 1620 may include feature annotating & labeling engine 1622 (e.g., configured to annotate or label features from a model or data, which may be extracted by feature extraction engine 1624), feature extraction engine 1624 (e.g., configured to extract one or more features from a model or data), and/or feature scaling & selection engine 1626 Feature scaling & selection engine 1626 may be configured to determine, select, limit, constrain, concatenate, or define features (e.g., AI features) for use with AI models.

System 1600 may also include machine learning (ML) ML modeling engine 1630, which may be configured to execute one or more operations on a machine learning model (e.g., model training, model re-configuration, model validation, model testing), such as those described in the processes described herein. For example, ML modeling engine 1630 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 1602a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 1630 may include model selector engine 1632 (e.g., configured to select a model from among a plurality of models, such as based on input data), parameter engine 1634 (e.g., configured to add, remove, and/or change one or more parameters of a model), and/or model generation engine 1636 (e.g., configured to generate one or more machine learning models, such as according to model input data, model output data, comparison data, and/or validation data).

In some aspects, model selector engine 1632 may be configured to receive input and/or transmit output to ML algorithms database 1670. Similarly, featurization engine 1620 can utilize storage or system memory for storing data and can utilize one or more I/O devices or network interfaces for transmitting or receiving data. ML algorithms database 1670 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 1670 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 1670 include versions DALL. E, CHAT GPT, and SORA, all provided by OPEN AI.

System 1600 can further include predictive output generation engine 1645 and output validation engine 1650 (e.g., configured to apply validation data to machine learning model output). Predictive output generation engine 1645 can analyze the input and identify relevant patterns and associations in the data it has learned to generate a sequence of words that predictive output generation engine 1645 predicts is the most likely continuation of the input using one or more models from the ML algorithms database 1670, aiming to provide a coherent and contextually relevant answer. Predictive output generation engine 1645 generates responses by sampling from the probability distribution of possible words and sequences, guided by the patterns observed during its training. In some aspects, predictive output generation engine 1645 can generate multiple possible responses before presenting the final one. Predictive output generation engine 1645 can generate multiple responses based on the input, and these responses are variations that predictive output generation engine 1645 considers potentially relevant and coherent. Output validation engine 1650 can evaluate these generated responses based on certain criteria. These criteria can include relevance to the prompt, coherence, fluency, and sometimes adherence to specific guidelines or rules, depending on the application. Based on this evaluation, output validation engine 1650 selects the most appropriate response. This selection is typically the one that scores highest on the set criteria, balancing factors like relevance, informativeness, and coherence.

System 1600 can further include feedback engine 1660 (e.g., configured to apply feedback from a user and/or machine to a model) and model refinement engine 1655 (e.g., configured to update or re-configure a model). In some aspects, feedback engine 1660 may receive input and/or transmit output (e.g., output from a trained, partially trained, or untrained model) to outcome metrics database 1665. Outcome metrics database 1665 may be configured to store output from one or more models and may also be configured to associate output with one or more models. In some aspects, outcome metrics database 1665, or other device (e.g., model refinement engine 1655 or feedback engine 1660), may be configured to correlate output, detect trends in output data, and/or infer a change to input or model parameters to cause a particular model output or type of model output. In some aspects, model refinement engine 1655 may receive output from predictive output generation engine 1645 or output validation engine 1650. In some aspects, model refinement engine 1655 may transmit the received output to featurization engine 1620 or ML modeling engine 1630 in one or more iterative cycles.

The engines of system 1600 may be packaged functional hardware units designed for use with other components or a part of a program that performs a particular function (e.g., of related functions). Any or each of these modules may be implemented using a computing device. In some aspects, the functionality of system 1600 may be split across multiple computing devices to allow for distributed processing of the data, which may improve output speed and reduce computational load on individual devices. In some aspects, system 1600 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 1600 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

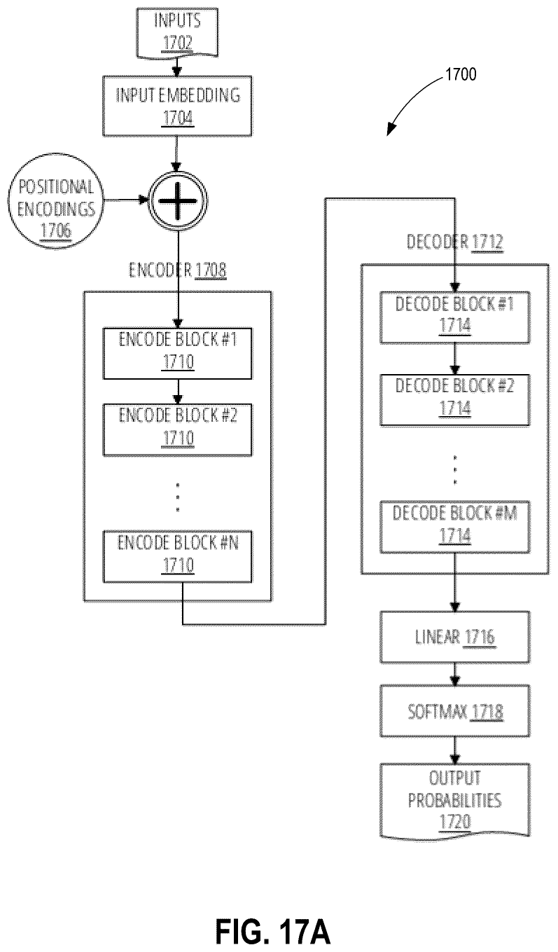

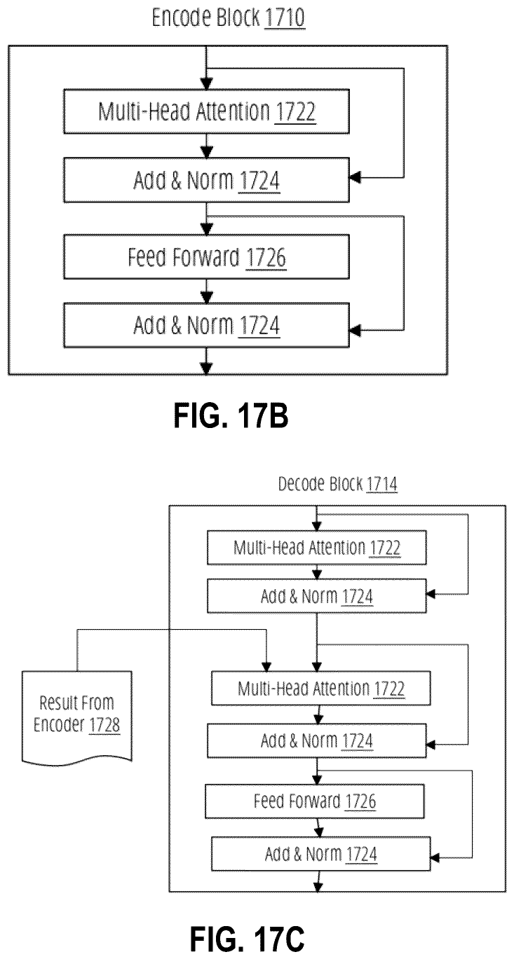

FIG. 17A, FIG. 17B, and FIG. 17C illustrate an example transformer architecture in accordance with some aspects of the present technology. Examples of ML models that use a transformer neural network (e.g., transformer architecture 1700) can include, e.g., generative pretrained transformer (GPT) models and Bidirectional Encoder Representations from Transformer (BERT) models. Transformer architecture 1700, which is illustrated in FIG. 17A, FIG. 17B, and FIG. 17C, includes inputs 1702, input embedding block 1704, positional encodings 1706, encoder 1708 including encode blocks 1710, decoder 1712 including decode blocks 1714, linear block 1716, softmax block 1718, and output probabilities 1720.

Input embedding block 1704 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 1704 can be learned embeddings to convert the input tokens and output tokens to vectors of dimension that have the same dimension as the positional encodings, for example.

Positional encodings 1706 provide information about the relative or absolute position of the tokens in the sequence. According to certain non-limiting examples, positional encodings 1706 can be provided by adding positional encodings to the input embeddings at the inputs to the encoder 1708 and decoder 1712. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 1708 can use stacked self-attention and point-wise, fully connected layers. Encoder 1708 can be a stack of N identical layers (e.g., N=6), and each layer can be an encode block, as illustrated by encode block 1710 shown in FIG. 17B. Each encode block 1710 has two sub-layers: (i) a first sub-layer has a multi-head attention block 1722 and (ii) a second sub-layer has a feed forward block 1726, which can be a position-wise fully connected feed-forward network. The feed forward block 1726 can use a rectified linear unit (ReLU).

Encoder 1708 uses a residual connection around each of the two sub-layers, followed by an add & norm block 1724, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 1708, decoder 1712 uses stacked self-attention and point-wise, fully connected layers. Decoder 1712 can also be a stack of M identical layers (e.g., M=6), and each layer can be a decode block, as illustrated by decode block 1712 shown in FIG. 17B. In addition to the two sub-layers (i.e., the sublayer with multi-head attention block 1722 and the sub-layer with feed forward block 1726) found in encode block 1710, decode block 1714 can include a third sub-layer, which performs multi-head attention over the output of the encoder stack. Similar to encoder 1708, decoder 1712 uses residual connections around each of the sub-layers, followed by layer normalization. Additionally, the sub-layer with multi-head attention block 1722 can be modified in the decoder stack to prevent positions from attending to subsequent positions. This masking, combined with the fact that the output embeddings are offset by one position, can ensure that the predictions for position i can depend only on the known output data at positions less than i.

Linear block 1716 can be a learned linear transformation. For example, when transformer architecture 1700 is being used to translate from a first language into a second language, linear block 1716 can project the output from the last decode softmax block 1718 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 1718 then turns the scores from linear block 1716 into output probabilities 1720 (which add up to 1.0). In each position, the index provides for the word with the highest probability, and then maps that index to the corresponding word in the vocabulary. Those words then form the output sequence of transformer architecture 1700. The softmax operation is applied to the output from linear block 1716 to convert the raw numbers into output probabilities 1720 (e.g., token probabilities).

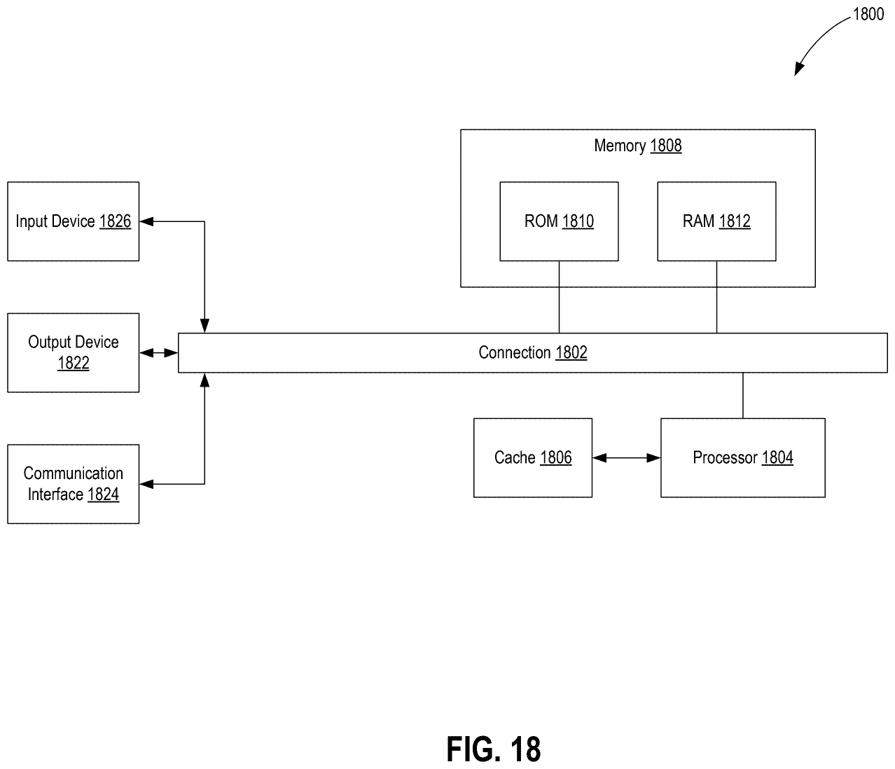

FIG. 18 shows an example of computing system 1800, which can be, for example, any computing device making up any part illustrated in FIG. 1 or any component thereof.

In some aspects, computing system 1800 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 1800 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1800 includes at least one processing unit (CPU or processor) 1804 and connection 1802 that couples various system components including system memory 1808, such as read-only memory (ROM) 1810 and random access memory (RAM) 1812 to processor 1804. Memory 1808 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 1808 can include software services, servers, logic, etc., that when the code that defines such software is executed by the processor 1804, it causes the system to perform a function. In some aspects, a hardware service that performs a particular function can include the software component stored in a computer-readable medium in connection with the necessary hardware components, such as processor 1804, connection 1802, output device 1822, etc., to carry out the function.

Computing system 1800 can include a cache of high-speed memory 1806 connected directly with, in close proximity to, or integrated as part of processor 1804.

Connection 1802 can be a physical connection via a bus, or a direct connection into processor 1804, such as in a chipset architecture. Connection 1802 can also be a virtual connection, networked connection, or logical connection.

Processor 1804 can include any general purpose processor and a hardware service or software service stored in memory 1808, configured to control processor 1804 as well as a special-purpose processor where software instructions are incorporated into the actual processor design. Processor 1804 may essentially be a completely self-contained computing system, containing multiple cores or processors, a bus, memory controller, cache, etc. A multi-core processor may be symmetric or asymmetric. Processor 1804 can be physical or virtual.

To enable user interaction, computing system 1800 includes an input device 1826, which can represent any number of input mechanisms, such as a microphone for speech, a touch-sensitive screen for gesture or graphical input, keyboard, mouse, motion input, speech, etc. Computing system 1800 can also include output device 1822, which can be one or more of a number of output mechanisms known to those of skill in the art. In some instances, multimodal systems can enable a user to provide multiple types of input/output to communicate with computing system 1800. Computing system 1800 can include communication interface 1824, which can generally govern and manage the user input and system output. There is no restriction on operating on any particular hardware arrangement, and therefore the basic features here may easily be substituted for improved hardware or firmware arrangements as they are developed.

In some aspects, computing system 1800 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some examples, a service is a program or a collection of programs that carry out a specific function. In some examples, a service can be considered a server. The memory can be a non-transitory computer-readable medium.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embo died in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Aspects:

The present technology includes computer-readable storage mediums for storing instructions, and systems for executing any one of the methods embodied in the instructions addressed in the Aspects of the present technology presented below:
Aspect 1. A method for selectively interacting with a portion of an asset by a generative response engine while leaving a non-selected portion of the asset unchanged, the method comprising: receiving a prompt referring to a portion of the asset and requesting a revision to the portion of the asset, wherein the prompt includes a referenced portion of the asset and implies an unreferenced portion of the asset; generating a response to the prompt, wherein generated tokens are intended to replace the referenced portion of asset, but not the unreferenced portion of the asset; and applying the response to the prompt to the asset by replacing the referenced portion of the asset.
Aspect 2. The method of Aspect 1, wherein the referenced portion of the asset is referenced through a selection of the referenced portion of the asset in a user interface displaying the asset.
Aspect 3. The method of any of Aspects 1-2, further comprising: providing instructions to the user interface displaying the asset to visually select the referenced portion of the asset, and to replace the visually selected portion of the asset with the response to the prompt.
Aspect 4. The method of Aspect 3, further comprising: generating, a RegEX string that instructs the user interface which portion of the asset to visually select.
Aspect 5. The method of any of Aspects 3-4, wherein the generative response engine streams characters in the RegEX string to the user interface, whereby the user interface can expand the visually selected portion of the referenced portion in response to receiving additional characters in the RegEX sting.
Aspect 6. The method of any of Aspects 1-5, further comprising: determining, by the generative response engine, the selected portion based on the selection of the portion of the asset.
Aspect 7. The method of any of Aspects 1-6, further comprising: receiving a first prompt; generating the asset in response to the first prompt; determining, by the generative response engine, that the asset generated in response to the first prompt should be displayed in a collaborative surface; displaying the asset generated in response to the first prompt in the collaborative surface outside of a conversational interface that is provided for dialogue with the generative response engine.
Aspect 8. The method of any of Aspects 1-7, further comprising: prior to the displaying the asset generated in response to the first prompt, determining a type for the asset, wherein the collaborative surface is rendered with properties associated with the type.
Aspect 9. The method of any of Aspects 1-8, further comprising: receiving the asset by the generative response engine, wherein the asset is from a file provided to the generative response engine by a user account or the asset is from a file provided to the generative response engine by a third-party application through an API.
Aspect 10. The method of any of Aspects 1-9, further comprising: displaying revision markups to indicate a difference between the referenced portion of the asset and the replaced reference portion of the asset.
Aspect 11. The method of Aspect 10, the revision markups are generated by the method comprising: recording, by a front end interface to the generative response engine, the referenced portion of the asset in a history log; and comparing, by the front end interface to the generative response engine, the referenced portion of the asset recorded in the history log with the replaced referenced portion of the asset.
Aspect 12. The method of any of Aspects 1-11, further comprising: recording, by a front end interface to the generative response engine, the referenced portion of the asset in a collaborative asset service; receiving an undo operation; and restoring the referenced portion of the asset from the collaborative asset service.
Aspect 13. The method of any of Aspects 1-12, further comprising: receiving a second prompt, by the generative response engine, the second prompt instructing the generative response engine to make suggestions on the asset; generating, by the generative response engine, at least one suggestion; anchoring, by a front end interface to the generative response engine a comment to a location in the asset to which the at least one suggestion pertains, the comment includes the at least one suggestion.
Aspect 14. The method of any of Aspects 1-13, further comprising: displaying, by the front end interface to the generative response engine, a user interface object that is mapped to a common prompt to be provided by a user account when interacting with the asset, wherein the receiving the second prompt is a result of receiving a selection of the user interface object.
Aspect 15. A non-transitory computer-readable medium having stored thereon instructions that, when executed by at least one processor, cause the at least one processor to perform operations according to any of Aspects 1 to 14.
Aspect 16. A computing system for performing a function, comprising one or more means for performing operations according to any of Aspects 1 to 14.
Aspect 17. A method for interacting with an asset by a generative response engine in a collaborative surface, the method comprising: triggering, by the generative response engine, the collaborative surface of a front end based on a context of a first prompt, wherein the generative response engine has been post-trained to determine to trigger the collaborative surface of the front end; receiving, by the generative response engine, a second prompt and a current version of the asset, wherein the second prompt contains an instruction for modifying the current version of the asset and wherein at least a portion of the current version of the asset was modified by the user account via the collaborative surface; modifying, by the generative response engine, the current version of the asset based on the instruction, thereby generating tokens to create an updated version of the asset; and providing, to the front end, the updated version of the asset for display via the collaborative surface.
Aspect 18. The method of Aspect 17, further comprising: creating, by the generative response engine, regular expressions (REGEX) patterns to identify text of the asset that should be selected and replaced in creating the updated version of the asset.
Aspect 19. The method of any of Aspects 17-18, wherein an interactive interface of the front end comprises a conversational interface and the collaborative surface, wherein the collaborative surface facilitates interaction with the asset by the user account.
Aspect 20. The method of Aspect 19, wherein the at least a portion of the current version of the asset was modified via the collaborative surface of the interactive interface, and the first prompt and the second prompt were provided to the generative response engine via the conversational interface.
Aspect 21. The method of any of Aspects 17-20, wherein the current version of the asset is provided to the generative response engine in a whisper message, wherein the whisper message is not displayed to the user in the conversational interface.
Aspect 22. The method of any of Aspects 17-21, wherein determining to trigger the collaborative surface of the front end is based on the context indicating an intent of a user account to collaborate with the generative response engine on the asset.
Aspect 23. The method of any of Aspects 17-22, further comprising: receiving, by the generative response engine, a message history comprising the first prompt and the second prompt, wherein the message history can include a subsequent prompt.
Aspect 24. The method of any of Aspects 17-23, wherein the generative response engine is post-trained on generated synthetic data using unsupervised learning techniques.
Aspect 25. A non-transitory computer-readable medium having stored thereon instructions that, when executed by at least one processor, cause the at least one processor to perform operations according to any of Aspects 17 to 24.
Aspect 26. A computing system for performing a function, comprising one or more means for performing operations according to any of Aspects 17 to 24.
Aspect 27. A method comprising: receiving, at a front end of a generative response engine, a streamed sequence of tokens from the generative response engine; predicting, by a model of the front end, a next token in the streamed sequence of tokens; and based on the prediction, displaying a predicted output of the generative response engine via a collaborative surface of the front end.
Aspect 28. The method of Aspect 27, wherein the streamed sequence of tokens comprises an incomplete segment of a JSON string.
Aspect 29. The method of Aspect 28, wherein predicting the next token in the streamed sequence of tokens comprises resolving, by the model, an ambiguity of the next token to complete the incomplete segment of the JSON string, thereby generating a complete JSON string that can be parsed by the front end and displayed via the collaborative surface.
Aspect 30. The method of any of Aspects 27-29, wherein displaying the predicted output based on the streamed sequence of tokens gives an appearance of the output being gradually displayed via the collaborative surface.
Aspect 31. The method of any of Aspects 27-30, wherein the streamed sequence of tokens is received at the front end in response to a prompt from a user account for modifying, by the generative response engine, a selected portion of an asset, and wherein the method further comprises: displaying, based on the predicted output of the generative response engine, modified text of the selected portion of the asset thereby replacing original text of the selected portion of the asset in the collaborative surface.
Aspect 32. The method of any of Aspects 27-31, wherein the streamed sequence of tokens is received at the front end in response to a prompt from a user account for modifying, by the generative response engine, a code segment of an asset, and wherein the method further comprises: displaying, based on the predicted output of the generative response engine, modified code of the code segment of the asset thereby replacing original code of the code segment of the asset in the collaborative surface.
Aspect 33. A non-transitory computer-readable medium having stored thereon instructions that, when executed by at least one processor, cause the at least one processor to perform operations according to any of Aspects 27 to 32.
Aspect 34. A computing system for performing a function, comprising one or more means for performing operations according to any of Aspects 27 to 32.
Aspect 35. A method comprising: displaying the asset in the collaborative surface of the front end of the generative response engine, wherein the collaborative surface enables interaction with the asset by the generative response engine and the user account; receiving, at the front end, a prompt for revising the asset, wherein the prompt is received from the user account via the collaborative surface; providing the prompt and the asset to the generative response engine; receiving, from the generative response engine, output associated with a revised version of the asset; displaying the revised version of the asset in the collaborative surface based on the output; and receiving, via the collaborative surface, an edit of the revised version of the asset from the user.
Aspect 36. The method of Aspect 35, wherein the revising version of the asset comprises a suggestion of the generative response engine based on the prompt, wherein the suggestion is displayed in a comment bubble.
Aspect 37. The method of Aspect 36, further comprising: receiving a second prompt from the user account instructing the generative response engine to apply the suggestion to the asset.
Aspect 38. The method of any of Aspects 35-37, wherein the prompt is based on receipt, by the front end, of a selection of a user interface button of a set of user interface buttons, wherein respective user interface buttons map to commands for revising or commenting on the asset.
Aspect 39. The method of any of Aspects 35-38, wherein the front end and the generative response engine are communicatively coupled to a system architecture server comprising a collaborative asset service.
Aspect 40. The method of any of Aspects 35-39, further comprising: reporting, by the generative response engine, the revised version of the asset to the collaborative asset service, wherein the collaborative asset service stores an event-sourced representation of the asset with revisions stored as discreet events.
Aspect 41. The method of any of Aspects 35-40, further comprising: reporting, by the front end, the edit from the user to the collaborative asset service.
Aspect 42. The method of any of Aspects 35-41, wherein the displaying the asset is based on rendering, by the front end, the asset from the collaborative asset service.
Aspect 43. The method of any of Aspects 35-42, further comprising: receiving, at the front end, an undo prompt for undoing the edit of the revised version of the asset; and receiving, from the collaborative asset service, a reconstructed version of the asset without the edit from the user, wherein the reconstructed version of the asset is generated by the collaborative asset service based on the event-sourced representation of the asset.
Aspect 44. A non-transitory computer-readable medium having stored thereon instructions that, when executed by at least one processor, cause the at least one processor to perform operations according to any of Aspects 35 to 43.
Aspect 45. A computing system for performing a function, comprising one or more means for performing operations according to any of Aspects 35 to 43.

The present technology includes computer-readable storage mediums for storing instructions, and systems for executing any one of the methods embodied in the instructions addressed in the aspects of the present technology presented below:

1. A method comprising:
receiving, in a conversational interface of a front end to a generative response engine, a first prompt from a user account;
triggering, by the generative response engine, a collaborative surface of the front end distinct from the conversational interface of the front end, wherein triggering occurs in response to a determination by the generative response engine that a context of the first prompt satisfies a collaborative-interaction criterion;
outputting, by the generative response engine in response to the first prompt, an asset displayed in the collaborative surface, wherein the asset can be manipulated in the collaborative surface by the user account and the generative response engine and wherein manipulation of the asset by the user account can be used as prompts to the generative response engine;
displaying, by the front end via the collaborative surface, a current version of the asset wherein the current version of the asset is generated from user manipulation of the asset in the collaborative surface;
receiving, by the generative response engine, a second prompt and the current version of the asset, wherein the second prompt contains an instruction for modifying the current version of the asset;
modifying, by the generative response engine, the current version of the asset based on the instruction using tokens output by the generative response engine to create an updated version of the asset, wherein the tokens are sampled by the generative response engine from a probability distribution of possible tokens; and
providing, to the front end, the updated version of the asset for display via the collaborative surface.

2. The method of claim 1, further comprising:
creating, by the generative response engine, a regular expression (RegEX) string to identify text of the asset that should be selected and replaced in creating the updated version of the asset.

3. The method of claim 2, wherein the RegEX string instructs the collaborative surface to visually select the text of the asset that should be selected and replaced.

4. The method of claim 1, wherein an interactive interface of the front end comprises a conversational interface and the collaborative surface, wherein the collaborative surface facilitates interaction with the asset by the user account.

5. The method of claim 4, wherein the at least a portion of the current version of the asset was modified via the collaborative surface of the interactive interface, and the first prompt and the second prompt were provided to the generative response engine via the conversational interface.

6. The method of claim 5, wherein the current version of the asset is provided to the generative response engine in a whisper message, wherein the whisper message is not displayed to the user in the conversational interface.

7. The method of claim 1, wherein determining to trigger the collaborative surface of the front end is based on the context indicating an intent of a user account to collaborate with the generative response engine on the asset.

8. The method of claim 1, further comprising:
receiving, by the generative response engine, a message history comprising the first prompt and the second prompt, wherein the message history can include a subsequent prompt.

9. The method of claim 1, wherein the generative response engine is post-trained on generated synthetic data using unsupervised learning techniques to determine when to trigger the collaborative surface.

10. The method of claim 1, further comprising:
storing, in a history log, the current version of the asset and the updated version of the asset
receiving, at the front end, an undo prompt for undoing the modification to create the updated version of the asset;
retrieving, from the history log, the current version of the asset; and
displaying the current version of the asset in the collaborative surface.

11. A computing system, comprising:
at least one processor; and
at least one memory storing instructions that, when executed by the at least one processor, configure the computing system to:
receive, in a conversational interface of a front end to a generative response engine, a first prompt from a user account;
trigger, by a generative response engine, a collaborative surface of the front end distinct from the conversational interface of the front end, wherein triggering occurs in response to a determination by the generative response engine that a context of the first prompt satisfies a collaborative-interaction criterion;
output, by the generative response engine in response to the first prompt, an asset displayed in the collaborative surface, wherein the asset can be manipulated in the collaborative surface by the user account and the generative response engine and wherein manipulation of the asset by the user account can be used as prompts to the generative response engine;
display, by the front end via the collaborative surface, a current version of the asset wherein the current version of the asset is generated from user manipulation of the asset in the collaborative surface;
receive, by the generative response engine, a second prompt and the current version of the asset, wherein the second prompt contains an instruction for modifying the current version of the asset;
modify, by the generative response engine, the current version of the asset based on the instruction using tokens output by the generative response engine to create an updated version of the asset, wherein the tokens are sampled by the generative response engine from a probability distribution of possible tokens; and
provide, to the front end, the updated version of the asset for display via the collaborative surface.

12. The computing system of claim 11, wherein the instructions further configure the computing system to:
create, by the generative response engine, a regular expression (RegEX) string to identify text of the asset that should be selected and replaced in creating the updated version of the asset.

13. The computing system of claim 12, wherein the RegEX string instructs the collaborative surface to visually select the text of the asset that should be selected and replaced.

14. The computing system of claim 11, wherein an interactive interface of the front end comprises the conversational interface and the collaborative surface, wherein the collaborative surface facilitates interaction with the asset by the user account.

15. The computing system of claim 14, wherein the at least a portion of the current version of the asset was modified via the collaborative surface of the interactive interface, and the first prompt and the second prompt were provided to the generative response engine via the conversational interface.

16. The computing system of claim 15, wherein the current version of the asset is provided to the generative response engine in a whisper message, wherein the whisper message is not displayed to the user in the conversational interface.

17. The computing system of claim 11, wherein determining to trigger the collaborative surface of the front end is based on the context indicating an intent of a user account to collaborate with the generative response engine on the asset.

18. The computing system of claim 11, wherein the instructions further configure the computing system to:
receive, by the generative response engine, a message history comprising the first prompt and the second prompt, wherein the message history can include a subsequent prompt.

19. The computing system of claim 11, wherein the generative response engine is post-trained on generated synthetic data using unsupervised learning techniques to determine when to trigger the collaborative surface.

20. A non-transitory computer-readable storage medium comprising instructions that when executed by at least one processor, cause the at least one processor to:
receive, in a conversational interface of a front end to a generative response engine, a first prompt from a user account;
trigger, by a generative response engine, a collaborative surface of the front end distinct from the conversational interface of the front, wherein triggering occurs in response to a determination by the generative response engine that a context of the first prompt satisfies a collaborative-interaction criterion;
output, by the generative response engine in response to the first prompt, an asset displayed in the collaborative surface, wherein the asset can be manipulated in the collaborative surface by the user account and the generative response engine and wherein manipulation of the asset by the user account can be used as prompts to the generative response engine;
display, by the front end via the collaborative surface, a current version of the asset wherein the current version of the asset is generated from user manipulation of the asset in the collaborative surface;
receive, by the generative response engine, a second prompt and the current version of the asset, wherein the second prompt contains an instruction for modifying the current version of the asset;
modify, by the generative response engine, the current version of the asset based on the instruction using tokens output by the generative response engine to create an updated version of the asset, wherein the tokens are sampled by the generative response engine from a probability distribution of possible tokens; and
provide, to the front end, the updated version of the asset for display via the collaborative surface.
